(19) United States
(12) Patent Application Publication
(10) Pub. No.: US 2013/0130898 A1
(43) Pub. Date: May 23, 2013

(54) Fungicidal Compositions

(71) Applicants: Markus Gewehr, Kastellaun (DE); Jochen Dietz, Karlsruhe (DE); Egon Haden, Speyer (DE)

(72) Inventors: Markus Gewehr, Kastellaun (DE); Jochen Dietz, Karlsruhe (DE); Egon Haden, Speyer (DE)

(21) Appl. No.: 13/813,753

(22) PCT Filed: Aug. 2, 2011
(86) PCT No.: PCT/EP2011/063310

§ 371 Date: Feb. 1, 2013

(30) Foreign Application Priority Data
Aug. 3, 2010 (EP) 10171780.9

(51) Int. Cl. A01N 43/56; A01N 43/653; A01N 43/54; A01N 43/78; A01N 63/04; A01N 43/80; A01N 43/82; A01N 43/50; A01N 63/00; A01N 43/40; A01N 43/42

(52) U.S. Cl. CPC A01N 43/56; A01N 43/40; A01N 43/653; A01N 43/54; A01N 43/78; A01N 43/42; A01N 43/80; A01N 43/82; A01N 43/50; A01N 63/00; A01N 63/04
USPC 504/116.1; 514/406; 514/357; 514/407; 514/383; 514/266.23; 514/350; 514/365; 514/312; 514/380; 514/326; 514/361; 514/400; 514/275; 514/55; 424/93.5; 424/93.462; 424/93.51

(57) ABSTRACT

The present invention relates to compositions of fungicidally active compounds comprising at least one active compound I selected from 3-difluoromethyl-1-methyl-1H-pyrazole-4-carboxylic acid (3′,4′,5′-trifluoro-biphenyl-2-yl)-amide (fluxapyroxade), bixafen, fluopyram, isopyrazam, sedaxane, penflufen and penthiopyrad and at least one further active component II as defined below. The invention furthermore relates to a method for controlling harmful fungi, wherein the fungi, their habitat or the plant propagation material, the soil, the plants or the materials to be protected against fungal attack are treated with an effective amount of at least one active compound I in combination with at least one active component II or with an effective amount of a composition according to the invention, to a method for protection of plant propagation material, comprising contacting the plant propagation material with an effective amount of at least one active compound I in combination with at least one active component II or with an effective amount of a composition according to the invention, to a method for protecting plants after germination from the attack of foliar phytopathogenic fungi, which comprises treating the plant propagation material from which the plants are to grow with an effective amount of at least one active compound I in combination with at least one active component II or with an effective amount of a composition according to the invention, to the use of the composition according to the invention for controlling harmful fungi, and to plant propagation material comprising the composition.

The present invention relates to compositions of fungicidally active compounds comprising at least one active compound I selected from 3-difluoromethyl-1-methyl-1H-pyrazole-4-carboxylic acid (3′,4′,5′-trifluoro-biphenyl-2-yl)-amide (fluxapyroxade), bixafen, fluopyram, isopyrazam, sedaxane, penflufen and penthiopyrad and at least one further active component II as defined below. The invention furthermore relates to a method for controlling harmful fungi, wherein the fungi, their habitat or the plant propagation material, the soil, the plants or the materials to be protected against fungal attack are treated with an effective amount of at least one active compound I in combination with at least one active component II or with an effective amount of a composition according to the invention, to a method for protection of plant propagation material, comprising contacting the plant propagation material with an effective amount of at least one active compound I in combination with at least one active component II or with an effective amount of a composition according to the invention, to a method for protecting plants after germination from the attack of foliar phytopathogenic fungi, which comprises treating the plant propagation material from which the plants are to grow with an effective amount of at least one active compound I in combination with at least one active component II or with an effective amount of a composition according to the invention, to the use of the composition according to the invention for controlling harmful fungi, and to plant propagation material comprising the composition.

One typical problem arising in the field of fungicidal control lies in the need to reduce the dosage rates of the active ingredient in order to reduce or avoid unfavorable environmental or toxicological effects whilst still allowing effective pest control.

Another problem encountered concerns the need to have available fungicidal agents which are effective against a broad spectrum of fungi.

There also exists the need for fungicidal agents that combine knock-down activity with prolonged control, that is, fast action with long lasting action.

A further problem arising with the use of fungicides is that the repeated and exclusive application of an individual fungicidal compound often leads to a rapid selection of harmful fungi which have developed natural or adapted resistance against the active compound in question. Normally, such fungi strains are also cross-resistant against other active ingredients having the same mode of action. An effective control of the pathogens with said active compounds is then not possible anymore. However, active ingredients having new mechanisms of action are difficult and expensive to develop.

Another problem underlying the present invention is the desire for compositions that improve plants, a process which is commonly and hereinafter referred to as “plant health”. The term “plant health” comprises various sorts of improvements of plants that are not connected to the control of fungi. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), tillering increase, increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination; or any other advantages familiar to a person skilled in the art.

It was therefore an object of the present invention to provide fungicidal compositions which solve the problems of reducing the dosage rate and/or enhancing the spectrum of activity and/or combining knock-down activity with prolonged control and/or to resistance management and/or promoting the health of plants.

Applicants surprisingly found that these objects are in part or in whole achieved by the combination of certain fungicidal compounds I as defined hereinafter with certain other active components II.

Especially, it has been found that a composition containing at least one compound I as defined hereinafter and at least one component II as defined hereinafter show markedly enhanced action against fungi compared to the control rates that are possible with the individual compounds and/or is suitable for improving the health of plants when applied to plants, parts of plants, seeds, or at their locus of growth.

It has been found that the action of the compositions of the invention goes far beyond the fungicidal and/or plant health improving action of the active compounds present in the mixture alone.

Moreover, we have found that simultaneous, that is joint or separate, application of a compound I and a component II or successive application of a compound I and the components II allows enhanced control of harmful fungi, compared to the control rates that are possible with the individual compounds (synergistic compositions).

Therefore the present invention relates to compositions of fungicidally active ingredients, comprising, as active components,
1) at least one active compound I selected from 3-difluoromethyl-1-methyl-1H-pyrazole-4-carboxylic acid (3′,4′,5′-trifluoro-biphenyl-2-yl)-amide (fluxapyroxade), bixafen, fluopyram, isopyrazam, sedaxane, penflufen and penthiopyrad; and
2) at least one active component II, selected from the active compound groups A) to D):
   A) strobilurins:
   coumethoxystrobin, coumoxystrobin, pyrametostrobin, pyraoxystrobin, N-methoxy-[2-(3,5,6-trichloro-pyridin-2-yloxymethyl)-phenyl]-carbamic acid methyl ester, 2-[2-(5-cyano-2-methyl-phenoxymethyl)-phenyl]-3-methoxy-acrylic acid methyl ester and 3-methoxy-2-{2-[2-methoxy-5-(methoxyimino-methyl)phenoxymethyl]-phenyl}-acrylic acid methyl ester;
   B) azoles: dichlobutrazole, etaconazole and quinconazole;
   C) heterocyclic compounds:
   clazafenone (pyriofenone), ethaboxam, flutianil, pyrimorph, tebufloquin, 2-(4-chloro-phenyl)-N-[4-(3,4-dimethoxy-phenyl)-isoxazol-5-yl]-2-prop-2-ynyloxy-acetamide (IIa)

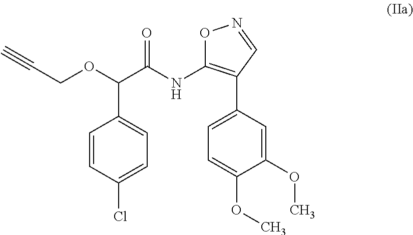 [SMILES: C#CCOC(C(=O)Nc1oncc1-c1ccc(OC)c(OC)c1)c1ccc(Cl)cc1]

2-{1-[2-(5-methyl-3-trifluoromethyl-pyrazol-1-yl)-acetyl]-piperidin-4-yl}-thiazole-4-carboxylic acid methyl-(R)-1,2,3,4-tetrahydro-naphthalen-1-yl-amide (IIb)

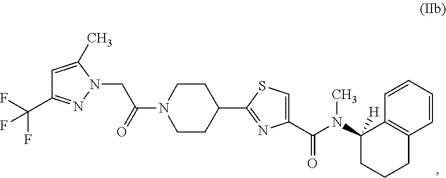 [SMILES: Cc1cc(C(F)(F)F)nn1CC(=O)N1CCC(c2nc(C(=O)N(C)[C@@H]3CCCc4ccccc43)cs2)CC1]

4-cyclopropyl-[1,2,3]thiadiazole-5-carboxylic acid 4-chloro-benzyl ester (IIc)

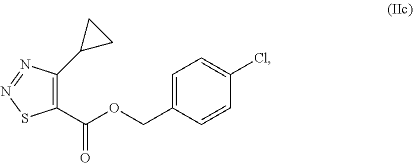 [SMILES: O=C(OCc1ccc(Cl)cc1)c1snnc1C1CC1]

4-cyclopropyl-[1,2,3]thiadiazole-5-carboxylic acid (2,4-dimethoxy-phenyl)-amide (IId)

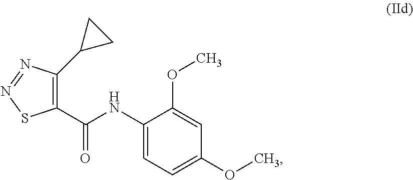 [SMILES: COc1ccc(NC(=O)c2snnc2C2CC2)c(OC)c1]

1-(2,4-dichloro-phenyl)-2-imidazol-1-yl-ethanone O-allyl-oxime (IIe)

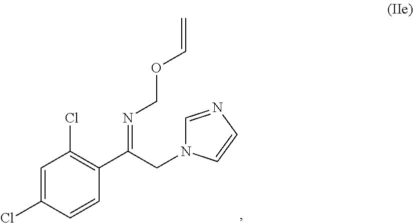 [SMILES: C=COC/N=C(\Cn1ccnc1)c1ccc(Cl)cc1Cl]

5-chloro-1-(4,6-dimethoxy-pyrimidin-2-yl)-2-methyl-1H-benzoimidazole (IIf)

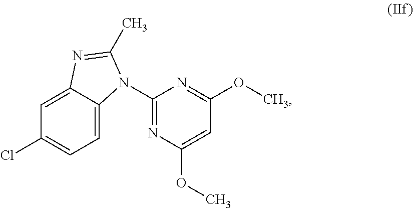 [SMILES: COc1cc(OC)nc(-n2c(C)nc3cc(Cl)ccc32)n1]

3-(2,3-dimethyl-5-p-tolyl-isoxazolidin-3-yl)-pyridine (IIg)

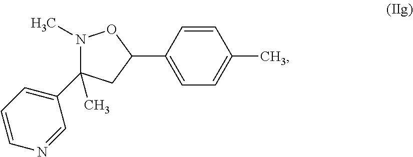 [SMILES: Cc1ccc(C2CC(C)(c3cccnc3)N(C)O2)cc1]

D) biologicals:

cocamidopropyl-betaine,
Ulocladium oudemansii, for example in form of the commercially available product BOTR^{y}-ZEN from BotryZen, New Zealand,
Chitosan, for example in form of the commercially available product ARMOURZEN from BotryZen, New Zealand,
Trichoderma atrovinde, for example from Kumiai, Japan,
Ampelomyces quisqualis, for example in form of the commercially available product AQ10 from Intrachem, Germany,
Aspergillus flavus, for example in form of the commercially available product AflaGuard® from Syngenta and Circle One Global, USA,
Aureobasidium pullulans, for example in form of the commercially available product Botector from Bio-ferm, Austria,
Bacillus subtilis, preferably var. Amyloliquefaciens FZB24, for example in form of the commercially available product Taegro from Novozymes, Denmark,
Candida oleophila, preferably strain I-182, for example in form of the commercially available product Aspire® from Ecogen, USA,
Candida saitoana, for example in form of the commercially available products Biocure or Biocoat from Microflo and Arysta, respectively, Japan
Clonostachys rosea f. catenulate, for example in form of the commercially available product Prestop® from Verdera, Finland,
Coniothyrium minitans, for example in form of the commercially available product Contans® from Prophyta, Germany
Cryphonectria parasitica, for example in form of the commercially available product Endothia parasitica from CNICM,
Cryptococcus albidus, for example in form of the commercially available product Yield plus from Anchor Biotech, South Africa,
Fusarium oxysporum, for example in form of the commercially available products Biofox or Fusaclean from Isagro, Italy and N.P.P., respectively,
Metschnikowia fructicola, for example in form of the commercially available product Shemer from Agrogreen, Israel,
Microdochium dimerum, for example in form of the commercially available product Antibot from Agrauxin, France,
Phlebiopsis gigantea, for example in form of the commercially available product Rotsop from Verdera, Finland,
Pseudozyma flocculosa, for example in form of the commercially available product Sporodex from Plant products, Canada,
Pythium oligandrum, preferably strain DV74, for example in form of the commercially available product Polyversum® from Firma Biopreparaty, Czech Republic,
Reynoutria sachlinensis, for example in form of the commercially available product Regalia from Marrone Biolnnovations, USA,
Talaromyces flavus, preferably strain V117b, for example in form of the commercially available product Protus® from Prophyta, Germany,
Trichoderma asperellum, preferably strain SKT-1, for example in form of the commercially available product Eco-Hope® from Kumiai, Japan,
Trichoderma atroviride, preferably strain LC52, for example in form of the commercially available product Sentinel® from Agrimm Technologies, New Zealand, Trichoderma harzianum,
preferably Trichoderma harzianum strain T-22, for example in form of the commercially available product PlantShield® T-22G from BioWorks, USA, or
Trichoderma harzianum strain TH 35, for example in form of the commercially available product ROOT PRO® from Mycontrol, Israel, or
Trichoderma harzianum strain T-39, for example in form of the commercially available products TRICHODEX or Trichoderma 2000 from Makhteshim and Mycontrol, respectively, Israel,
a mixture of Trichoderma harzianum & Trichoderma viride, for example in form of the commercially available product Trichopel® from Agrimm Technologies, New Zealand,
a mixture of Trichoderma harzianum strain ICC012 and Trichoderma viride strain ICC080, for example in form of the commercially available product Remedier®WP from Isagro Ricerca, Italy,
a mixture of Trichoderma polysporum and Trichoderma harzianum, for example in form of the commercially available product Binab® from Bio-Innovation, Sweden,
Trichoderma stromaticum, for example in form of the commercially available product Tricovab from CEPLAC, Brasil,
Trichoderma virens, preferably strain GL-21, for example in form of the commercially available product SoilGuard® 12G from Certis, USA,
Trichoderma viride, for example in form of the commercially available products Trieco or Bio-cure F from Ecosense labs, India, and Stanes, India, respectively,
Trichoderma viride strain TV1, for example in form of the commercially available product T. viride TV1 from Agribiotec srl, Italy;
in a synergistically effective amount.

The composition according to the invention may be a physical mixture of the at least one compound I and the at least one component II. Accordingly, the invention also provides a mixture comprising at least one compound I and at least one component II. However, the composition may also be any combination of at least one compound I with at least one component II, it not being required for compound(s) I and component(s) II to be present together in the same formulation.

An example of a composition according to the invention in which the at least one compound I and the at least one component II are not present together in the same formulation is a kit of parts. In a kit of parts, two or more components of a kit are packaged separately, i.e., not pre-formulated. As such, kits include one or more separate containers such as vials, cans, bottles, pouches, bags or canisters, each container containing a separate component for an agrochemical composition. One example is a two-component kit. Accordingly the present invention also relates to a two-component kit, comprising a first component which in turn comprises at least one compound I, a liquid or solid carrier and, if appropriate, at least one surfactant and/or at least one customary auxiliary, and a second component which in turn comprises at least one component II, a liquid or solid carrier and, if appropriate, at least one surfactant and/or at least one customary auxiliary. Suitable liquid and solid carriers, surfactants and customary auxiliaries are described below.

The “combined” use of at least one compound I with and at least one component II or the treatment according to the invention with the at least one compound I “in combination with” at least one component II on the one hand can be understood as using a physical mixture of at least one compound I and at least one component II. On the other hand, the combined use may also consist in using the at least one compound I and the at least one component II separately, but within a sufficiently short time of one another so that the desired effect can take place. More detailed illustrations of the combined use can be found in the specifications below.

In the context of the present invention, the term “plant” refers to an entire plant, a part of the plant or the propagation material of the plant, that is, the seed or the seedling.

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring. Preferably, it takes the form of seeds.

“Locus” means a plant, seed, soil, area, material or environment in which a pest is growing or may grow.

The compounds described herein and, optionally, all their isomers may be used in the form of their salts. Within the scope of this invention, agriculturally acceptable salts are preferred.

“Agriculturally acceptable salt” means a salt the cation of which is known and accepted in the art for the formation of salts for agricultural or horticultural use. Suitable agriculturally acceptable salts are especially the salts of those cations or the acid addition salts of those acids whose cations and anions, respectively, do not have any adverse effect on the action of the compounds according to the present invention. Preferably the salts are water-soluble. They can be formed in a customary method, e.g. by reacting the active compound with an acid of the anion in question if the active compound has a basic functionality or by reacting an acidic active compound with a suitable base.

Because some of the compounds I (and also some compounds II, e.g. the azoles of group B) have a basic center they can, for example, form acid addition salts. The same applies of course to compounds II having a basic center. Said acid addition salts are, for example, formed with mineral acids, typically sulfuric acid, nitric acid, a phosphoric acid or a hydrogen halide, such as hydrochloric acid or hydrobromic acid, with organic carboxylic acids, typically acetic acid, oxalic acid, malonic acid, maleic acid, fumaric acid or phthalic acid, with hydroxycarboxylic acids, typically ascorbic acid, lactic acid, malic acid, tartaric acid or citric acid, or with benzoic acid, or with organic sulfonic acids, typically methanesulfonic acid or p-toluenesulfonic acid.

Together with at least one acidic group, the compounds of formula I can also form salts with bases. Suitable salts with bases are, for example, metal salts, typically alkali metal salts; or alkaline earth metal salts, e.g. sodium salts, potassium salts or magnesium salts, or salts with ammonia or an organic amine, e.g. morpholine, piperidine, pyrrolidine, a mono-, di- or trialkylamine, typically ethylamine, diethylamine, triethylamine or dimethylpropylamine, or a mono-, di- or trihydroxyalkylamine, typically mono-, di- or triethanolamine. Where appropriate, the formation of corresponding internal salts is also possible.

The remarks made below with respect to preferred embodiments of the invention, especially to preferred compounds I and II, preferred weight ratios, preferred aspects of the methods and use according to invention apply both alone as well as in particular in any possible combination with each other.

The active compounds I and components II, their preparation and their action against harmful fungi are generally known (cf.: http://www.alanwood.net/pesticides/ and above information); these substances are commercially available. The compounds described by IUPAC nomenclature, their preparation and their fungicidal activity are also known (cf. Can. J. Plant Sci. 48(6), 587-94, 1968; EP-A 141 317; EP-A 152 031; EP-A 226 917; EP-A 243 970; EP-A 256 503; EP-A 428 941; EP-A 532 022; EP-A 1 028 125; EP-A 1 035 122; EP-A 1 201 648; EP-A 1 122 244, JP 2002316902; DE 19650197; DE 10021412; DE 102005009458; U.S. Pat. No. 3,296,272; U.S. Pat. No. 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624).

Preferred compounds I are selected from 3-difluoromethyl-1-methyl-1H-pyrazole-4-carboxylic acid (3′,4′,5′-trifluoro-biphenyl-2-yl)-amide (fluxapyroxade), bixafen, fluopyram, isopyrazam, penthiopyrad and mixtures thereof. More preferred compounds I are selected from 3-difluoromethyl-1-methyl-1H-pyrazole-4-carboxylic acid (3′,4′,5′-trifluoro-biphenyl-2-yl)-amide (fluxapyroxade), bixafen and isopyrazam and mixtures thereof. A specific compound I is 3-difluoromethyl-1-methyl-1H-pyrazole-4-carboxylic acid (3′,4′,5′-trifluoro-biphenyl-2-yl)-amide (fluxapyroxade).

Among the biologicals D of component II preference is given to cocamidopropyl-betaine,

Ulocladium oudemansii, for example in form of the commercially available product BOTRY-ZEN from BotryZen, New Zealand,
Chitosan, for example in form of the commercially available product ARMOUR-ZEN from BotryZen, New Zealand,
Trichoderma atroviride, for example from Kumiai, Japan,
Ampelomyces quisqualis, for example in form of the commercially available product AQ10 from Intrachem, Germany,
Aspergillus flavus, for example in form of the commercially available product AflaGuard® from Syngenta or Circle One Global, USA,
Aureobasidium pullulans, for example in form of the commercially available product Botector from Bio-ferm, Austria,
Bacillus subtilis var. Amyloliquefaciens FZB24, for example in form of the commercially available product Taegro from Novozymes, Denmark,
Candida oleophila I-182, for example in form of the commercially available product Aspire® from Ecogen, USA,
Candida saitoana, for example in form of the commercially available products Biocure or Biocoat from Microflo and Arysta, respectively, Japan
Clonostachys rosea f. catenulate, for example in form of the commercially available product Prestop® from Verdera, Finland,
Coniothyrium minitans, for example in form of the commercially available product Contans® from Prophyta, Germany
Cryphonectna parasitica, for example in form of the commercially available product Endothia parasitica from CNICM,
Cryptococcus albidus, for example in form of the commercially available product Yield plus from Anchor Biotech, South Africa,
Fusarium oxysporum, for example in form of the commercially available products Biofox or Fusaclean from Isagro, Italy and N.P.P., respectively,
Metschnikowia fructicola, for example in form of the commercially available product Shemer from Agrogreen, Israel,
Microdochium dimerum, for example in form of the commercially available product Antibot from Agrauxin, France,
Phlebiopsis gigantea, for example in form of the commercially available product Rotsop from Verdera, Finland,
Pseudozyma flocculosa, for example in form of the commercially available product Sporodex from Plant products, Canada,
Pythium oligandrum DV74, for example in form of the commercially available product Polyversum® from Firma Biopreparaty, Czech Republic,
Reynoutria sachlinensis, for example in form of the commercially available product Regalia from Marrone Biolnnovations, USA,
Talaromyces flavus V117b, for example in form of the commercially available product Protus® from Prophyta, Germany,
Trichoderma asperellum SKT-1, for example in form of the commercially available product Eco-Hope® from Kumiai, Japan,
Trichoderma atroviride LC52, for example in form of the commercially available product Sentinel® from Agrimm Technologies, New Zealand,
Trichoderma harzianum strain T-22, for example in form of the commercially available product PlantShield® T-22G from BioWorks, USA, or
Trichoderma harzianum TH 35, for example in form of the commercially available product ROOT PRO® from Mycontrol, Israel, or
Trichoderma harzianum T-39, for example in form of the commercially available products TRICHODEX or Trichoderma 2000 from Makhteshim and Mycontrol, respectively, Israel,
a mixture of Trichoderma harzianum & Trichoderma viride, for example in form of the commercially available product Trichopel® from Agrimm Technologies, New Zealand, a mixture of Trichoderma harzianum strain ICC012 and Trichoderma viride strain ICC080, for example in form of the commercially available product Remedier® WP from Isagro Ricerca, Italy,
a mixture of Trichoderma polysporum and Trichoderma harzianum, for example in form of the commercially available product Binab® from Bio-Innovation, Sweden, Trichoderma stromaticum, for example in form of the commercially available product Tricovab from CEPLAC, Brasil,
Trichoderma virens GL-21, for example in form of the commercially available product SoilGuard® 12G from Certis, USA,
Trichoderma viride, for example in form of the commercially available products Trieco or Bio-cure F from Ecosense labs, India, and Stanes, India, respectively,
Trichoderma viride TV1, for example in form of the commercially available product T. viride TV1 from Agribiotec srl, Italy.

Preferred components II are selected from clazafenone, ethaboxam, flutianil, pyrimorph, tebufloquin, the compound of formula IIa, the compound of formula IIb, the compound of formula IIf, chitosan, Trichoderma atroviride (preferably LC52), Ulocladium oudemansii and mixtures thereof. More preferred components II are selected from clazafenone, ethaboxam, flutianil, pyrimorph, the compound of formula IIa, the compound of formula IIb, chitosan, Trichoderma atroviride (preferably LC52), Ulocladium oudemansii and mixtures thereof.

In the compositions of the present invention, the at least one compound I and the at least one component II are present in synergistically effective amounts, i.e. in a weight ratio such that a synergistic effect takes place. This means that the relative amount, i.e. the weight ratio of the at least one compound I and the at least one component II in the composition provides for an increased fungicidal efficacy on at least one harmful fungus which exceeds the additive fungicidal efficacy of the compounds/components of the composition as calculated from the fungicidal efficacy of the individual compounds/components at a given application rate. The calculation of the additive fungicidal efficacies can be performed e.g. by Colby's formula (Colby, S. R. “Calculating synergistic and antagonistic responses of herbicide Combinations”, Weeds, 15, 20-22, 1967). Synergism is present if the observed efficacy is greater than the calculated efficacy.

To ensure synergism, the composition of the invention comprises the at least one compound I and the at least one component II in a total weight ratio of generally from 500:1 to 1:500, preferably from 100:1 to 1:100, more preferably from 50:1 to 1:50, even more preferably from 20:1 to 1:20, particularly preferably from 10:1 to 1:10 and in particular from 5:1 to 1:5.

According to the present invention, the composition according to the invention is preferably present in the form of a secondary or ternary composition, specifically of a secondary and tertiary mixture. Secondary compositions are those which contain one compound I and one component II.

Ternary compositions are those which contain one compound I and two different components II, hereinafter also referred to as component IIA and IIB, or two compounds I, hereinafter also referred to as compounds IA and IB, and one component II, the first variant being however preferred.

In the binary compositions of the present invention the compound I and the component II are usually present in a weight ratio of from 500:1 to 1:500, preferably from 100:1 to 1:100, more preferably from 50:1 to 1:50, even more preferably from 20:1 to 1:20, particularly preferably from 10:1 to 1:10, in particular from 5:1 to 1:5.

In the ternary compositions of the present invention the compound I and the two component IIA and IIB are usually present in a weight ratio of compound Ito compounds IIA+IIB of from 500:1 to 1:500, preferably from 100:1 to 1:100, more preferably from 50:1 to 1:50, even more preferably from 20:1 to 1:20, particularly preferably from 10:1 to 1:10, in particular from 5:1 to 1:5. The weight ratio of the first component IIA to the second component IIB is usually in the range from 100:1 to 1:100, more preferably from 50:1 to 1:50, in particular from 20:1 to 1:20.

In the alternative ternary compositions of the present invention the two compounds I (IA+IB) and the component II are usually present in a weight ratio of compounds IA+IB to component II of from 500:1 to 1:500, preferably from 100:1 to 1:100, more preferably from 50:1 to 1:50, even more preferably from 20:1 to 1:20, particularly preferably from 10:1 to 1:10, in particular from 5:1 to 1:5. The weight ratio of the first compound IA to the second compound IB is usually in the range from 100:1 to 1:100, more preferably from 50:1 to 1:50, in particular from 20:1 to 1:20.

A further embodiment relates to the compositions A-1 to A-392 listed in Table A, where a row of Table A corresponds in each case to a fungicidal composition comprising one compound I and one component II compiled in the respective row. The compositions described comprise the active substances in synergistically effective amounts, forexample in weight ratio of compound Ito component II of from 500:1 to 1:500, preferably from 100:1 to 1:100, more preferably from 50:1 to 1:50, even more preferably from 20:1 to 1:20, particularly preferably from 10:1 to 1:10, in particular from 5:1 to 1:5.

TABLE A

| Com- | | |
|---|---|---|
| position | Compound I | Component II |
| A-1 | Fluxapyroxade* | coumethoxystrobin |
| A-2 | Fluxapyroxade | coumoxystrobin |
| A-3 | Fluxapyroxade | pyrametostrobin |
| A-4 | Fluxapyroxade | pyraoxystrobin |
| A-5 | Fluxapyroxade | N-methoxy-[2-(3,5,6-trichloro-pyridin-2- |
| | | yloxymethyl)-phenyl]-carbamic acid methyl |
| | | ester |
| A-6 | Fluxapyroxade | 2-[2-(5-cyano-2-methyl-phenoxymethyl)- |
| | | phenyl]-3-methoxy-acrylic acid methyl |
| | | ester |
| A-7 | Fluxapyroxade | 3-methoxy-2-{2-[2-methoxy-5- |
| | | (methoxyimino-methyl)-phenoxymethyl]- |
| | | phenyl}-acrylic acid methyl ester |
| A-8 | Fluxapyroxade | dichlobutrazole |
| A-9 | Fluxapyroxade | etaconazole |
| A-10 | Fluxapyroxade | quinconazole |
| A-11 | Fluxapyroxade | clazafenone |
| A-12 | Fluxapyroxade | ethaboxam |
| A-13 | Fluxapyroxade | flutianil |
| A-14 | Fluxapyroxade | pyrimorph |
| A-15 | Fluxapyroxade | tebufloquin |
| A-16 | Fluxapyroxade | 2-(4-chloro-phenyl)-N-[4-(3,4-dimethoxy- |
| | | phenyl)-isoxazol-5-yl]-2-prop-2-ynyloxy- |
| | | acetamide (IIa) |
| A-17 | Fluxapyroxade | 2-{1-[2-(5-methyl-3-trifluoromethyl-pyrazol- |
| | | 1-yl)-acetyl]-piperidin-4-yl}-thiazole-4- |
| | | carboxylic acid methyl-(R)-1,2,3,4- |
| | | tetrahydro-naphthalen-1-yl-amide (IIb) |
| A-18 | Fluxapyroxade | 4-cyclopropyl-[1,2,3]thiadiazole-5- |
| | | carboxylic acid 4-chloro-benzyl ester (IIc) |
| A-19 | Fluxapyroxade | 4-cyclopropyl-[1,2,3]thiadiazole-5- |
| | | carboxylic acid (2,4-dimethoxy-phenyl)- |
| | | amide (IId) |
| A-20 | Fluxapyroxade | 1-(2,4-dichloro-phenyl)-2-imidazol-1-yl- |
| | | ethanone O-allyl-oxime (IIe) |
| A-21 | Fluxapyroxade | 5-chloro-1-(4,6-dimethoxy-pyrimidin-2-yl)- |
| | | 2-methyl-1H-benzoimidazole (IIf) |
| A-22 | Fluxapyroxade | 3-(2,3-dimethyl-5-p-tolyl-isoxazolidin-3-yl)- |
| | | pyridine (IIg) |
| A-23 | Fluxapyroxade | cocamidopropyl-betaine |
| A-24 | Fluxapyroxade | Ulocladium oudemansii, |
| A-25 | Fluxapyroxade | chitosan |
| A-26 | Fluxapyroxade | Trichoderma atroviride |
| A-27 | Fluxapyroxade | Ampelomyces quisqualis |
| A-28 | Fluxapyroxade | Aspergillus flavus |
| A-29 | Fluxapyroxade | Aureobasidium pullulans |
| A-30 | Fluxapyroxade | Bacillus subtilis var. Amyloliquefaciens |
| | | FZB24 |
| A-31 | Fluxapyroxade | Candida oleophila strain I-182 |
| A-32 | Fluxapyroxade | Candida saitoana |
| A-33 | Fluxapyroxade | Clonostachys rosea f. catenulate |
| A-34 | Fluxapyroxade | Coniothyrium minitans |
| A-35 | Fluxapyroxade | Cryphonectria parasitica |
| A-36 | Fluxapyroxade | Cryptococcus albidus |
| A-37 | Fluxapyroxade | Fusarium oxysporum |
| A-38 | Fluxapyroxade | Metschnikowia fructicola |
| A-39 | Fluxapyroxade | Microdochium dimerum |
| A-40 | Fluxapyroxade | Phlebiopsis gigantea |
| A-41 | Fluxapyroxade | Pseudozyma flocculosa |
| A-42 | Fluxapyroxade | Pythium oligandrum |
| A-43 | Fluxapyroxade | Reynoutria sachlinensis |
| A-44 | Fluxapyroxade | Talaromyces flavus strain V117b |
| A-45 | Fluxapyroxade | Trichoderma asperellum strain SKT-1 |
| A-46 | Fluxapyroxade | Trichoderma atroviride strain LC52 |
| A-47 | Fluxapyroxade | Trichoderma harzianum strain T-22 |
| A-48 | Fluxapyroxade | Trichoderma harzianum strain TH-35 |
| A-49 | Fluxapyroxade | Trichoderma harzianum strain T-39 |
| A-50 | Fluxapyroxade | a mixture of Trichoderma harzianum and |
| | | Trichoderma viride |
| A-51 | Fluxapyroxade | a mixture of Trichoderma harzianum strain |
| | | ICC012 and T. viride strain ICC080 |
| A-52 | Fluxapyroxade | a mixture of Trichoderma polysporum and |
| | | Trichoderma harzianum |
| A-53 | Fluxapyroxade | Trichoderma stromaticum |
| A-54 | Fluxapyroxade | Trichoderma virens strain GL-21 |
| A-55 | Fluxapyroxade | Trichoderma viride |
| A-56 | Fluxapyroxade | Trichoderma viride strain TV1 |
| A-57 | Bixafen | coumethoxystrobin |
| A-58 | Bixafen | coumoxystrobin |
| A-59 | Bixafen | pyrametostrobin |
| A-60 | Bixafen | pyraoxystrobin |
| A-61 | Bixafen | N-methoxy-[2-(3,5,6-trichloro-pyridin-2- |
| | | yloxymethyl)-phenyl]-carbamic acid methyl |
| | | ester |
| A-62 | Bixafen | 2-[2-(5-cyano-2-methyl-phenoxymethyl)- |
| | | phenyl]-3-methoxy-acrylic acid methyl |
| | | ester |
| A-63 | Bixafen | 3-methoxy-2-{2-[2-methoxy-5- |
| | | (methoxyimino-methyl)-phenoxymethyl]- |
| | | phenyl}-acrylic acid methyl ester |
| A-64 | Bixafen | dichlobutrazole |
| A-65 | Bixafen | etaconazole |
| A-66 | Bixafen | quinconazole |
| A-67 | Bixafen | clazafenone |
| A-68 | Bixafen | ethaboxam |
| A-69 | Bixafen | flutianil |
| A-70 | Bixafen | pyrimorph |
| A-71 | Bixafen | tebufloquin |
| A-72 | Bixafen | 2-(4-chloro-phenyl)-N-[4-(3,4-dimethoxy- |
| | | phenyl)-isoxazol-5-yl]-2-prop-2-ynyloxy- |
| | | acetamide (IIa) |
| A-73 | Bixafen | 2-{1-[2-(5-methyl-3-trifluoromethyl-pyrazol- |
| | | 1-yl)-acetyl]-piperidin-4-yl}-thiazole-4- |
| | | carboxylic acid methyl-(R)-1,2,3,4- |
| | | tetrahydro-naphthalen-1-yl-amide (IIb) |
| A-74 | Bixafen | 4-cyclopropyl-[1,2,3]thiadiazole-5- |
| | | carboxylic acid 4-chloro-benzyl ester (IIc) |
| A-75 | Bixafen | 4-cyclopropyl-[1,2,3]thiadiazole-5- |
| | | carboxylic acid (2,4-dimethoxy-phenyl)- |
| | | amide (IId) |
| A-76 | Bixafen | 1-(2,4-dichloro-phenyl)-2-imidazol-1-yl- |
| | | ethanone O-allyl-oxime (IIe) |
| A-77 | Bixafen | 5-chloro-1-(4,6-dimethoxy-pyrimidin-2-yl)- |
| | | 2-methyl-1H-benzoimidazole (IIf) |
| A-78 | Bixafen | 3-(2,3-dimethyl-5-p-tolyl-isoxazolidin-3-yl)- |
| | | pyridine (IIg) |
| A-79 | Bixafen | cocamidopropyl-betaine |
| A-80 | Bixafen | Ulocladium oudemansii, |
| A-81 | Bixafen | chitosan |
| A-82 | Bixafen | Trichoderma atroviride |
| A-83 | Bixafen | Ampelomyces quisqualis |
| A-84 | Bixafen | Aspergillus flavus |
| A-85 | Bixafen | Aureobasidium pullulans |
| A-86 | Bixafen | Bacillus subtilis var. Amyloliquefaciens |
| | | FZB24 |
| A-87 | Bixafen | Candida oleophila strain I-182 |
| A-88 | Bixafen | Candida saitoana |
| A-89 | Bixafen | Clonostachys rosea f. catenulate |
| A-90 | Bixafen | Coniothyrium minitans |
| A-91 | Bixafen | Cryphonectria parasitica |
| A-92 | Bixafen | Cryptococcus albidus |
| A-93 | Bixafen | Fusarium oxysporum |
| A-94 | Bixafen | Metschnikowia fructicola |
| A-95 | Bixafen | Microdochium dimerum |
| A-96 | Bixafen | Phlebiopsis gigantea |
| A-97 | Bixafen | Pseudozyma flocculosa |
| A-98 | Bixafen | Pythium oligandrum |
| A-99 | Bixafen | Reynoutria sachlinensis |
| A-100 | Bixafen | Talaromyces flavus strain V117b |
| A-101 | Bixafen | Trichoderma asperellum strain SKT-1 |
| A-102 | Bixafen | Trichoderma atroviride strain LC52 |
| A-103 | Bixafen | Trichoderma harzianum strain T-22 |
| A-104 | Bixafen | Trichoderma harzianum strain TH-35 |
| A-105 | Bixafen | Trichoderma harzianum strain T-39 |
| A-106 | Bixafen | a mixture of Trichoderma harzianum and |
| | | Trichoderma viride |
| A-107 | Bixafen | a mixture of Trichoderma harzianum strain |
| | | ICC012 and T. viride strain ICC080 |
| A-108 | Bixafen | a mixture of Trichoderma polysporum and |
| | | Trichoderma harzianum |
| A-109 | Bixafen | Trichoderma stromaticum |
| A-110 | Bixafen | Trichoderma virens strain GL-21 |
| A-111 | Bixafen | Trichoderma viride |
| A-112 | Bixafen | Trichoderma viride strain TV1 |
| A-113 | Fluopyram | coumethoxystrobin |
| A-114 | Fluopyram | coumoxystrobin |
| A-115 | Fluopyram | pyrametostrobin |
| A-116 | Fluopyram | pyraoxystrobin |
| A-117 | Fluopyram | N-methoxy-[2-(3,5,6-trichloro-pyridin-2- |
| | | yloxymethyl)-phenyl]-carbamic acid methyl |
| | | ester |
| A-118 | Fluopyram | 2-[2-(5-cyano-2-methyl-phenoxymethyl)- |
| | | phenyl]-3-methoxy-acrylic acid methyl |
| | | ester |
| A-119 | Fluopyram | 3-methoxy-2-{2-[2-methoxy-5- |
| | | (methoxyimino-methyl)-phenoxymethyl]- |
| | | phenyl}-acrylic acid methyl ester |
| A-120 | Fluopyram | dichlobutrazole |
| A-121 | Fluopyram | etaconazole |
| A-122 | Fluopyram | quinconazole |
| A-123 | Fluopyram | clazafenone |
| A-124 | Fluopyram | ethaboxam |
| A-125 | Fluopyram | flutianil |
| A-126 | Fluopyram | pyrimorph |
| A-127 | Fluopyram | tebufloquin |
| A-128 | Fluopyram | 2-(4-chloro-phenyl)-N-[4-(3,4-dimethoxy- |
| | | phenyl)-isoxazol-5-yl]-2-prop-2-ynyloxy- |
| | | acetamide (IIa) |
| A-129 | Fluopyram | 2-{1-[2-(5-methyl-3-trifluoromethyl-pyrazol- |
| | | 1-yl)-acetyl]-piperidin-4-yl}-thiazole-4- |
| | | carboxylic acid methyl-(R)-1,2,3,4- |
| | | tetrahydro-naphthalen-1-yl-amide (IIb) |
| A-130 | Fluopyram | 4-cyclopropyl-[1,2,3]thiadiazole-5- |
| | | carboxylic acid 4-chloro-benzyl ester (IIc) |
| A-131 | Fluopyram | 4-cyclopropyl-[1,2,3]thiadiazole-5- |
| | | carboxylic acid (2,4-dimethoxy-phenyl)- |
| | | amide (IId) |
| A-132 | Fluopyram | 1-(2,4-dichloro-phenyl)-2-imidazol-1-yl- |
| | | ethanone O-allyl-oxime (IIe) |
| A-133 | Fluopyram | 5-chloro-1-(4,6-dimethoxy-pyrimidin-2-yl)- |
| | | 2-methyl-1H-benzoimidazole (IIf) |
| A-134 | Fluopyram | 3-(2,3-dimethyl-5-p-tolyl-isoxazolidin-3-yl)- |
| | | pyridine (IIg) |
| A-135 | Fluopyram | cocamidopropyl-betaine |
| A-136 | Fluopyram | Ulocladium oudemansii, |
| A-137 | Fluopyram | chitosan |
| A-138 | Fluopyram | Trichoderma atroviride |
| A-139 | Fluopyram | Ampelomyces quisqualis |
| A-140 | Fluopyram | Aspergillus flavus |
| A-141 | Fluopyram | Aureobasidium pullulans |
| A-142 | Fluopyram | Bacillus subtilis var. Amyloliquefaciens |
| | | FZB24 |
| A-143 | Fluopyram | Candida oleophila strain I-182 |
| A-144 | Fluopyram | Candida saitoana |
| A-145 | Fluopyram | Clonostachys rosea f. catenulate |
| A-146 | Fluopyram | Coniothyrium minitans |
| A-147 | Fluopyram | Cryphonectria parasitica |
| A-148 | Fluopyram | Cryptococcus albidus |
| A-149 | Fluopyram | Fusarium oxysporum |
| A-150 | Fluopyram | Metschnikowia fructicola |
| A-151 | Fluopyram | Microdochium dimerum |
| A-152 | Fluopyram | Phlebiopsis gigantea |
| A-153 | Fluopyram | Pseudozyma flocculosa |
| A-154 | Fluopyram | Pythium oligandrum |
| A-155 | Fluopyram | Reynoutria sachlinensis |
| A-156 | Fluopyram | Talaromyces flavus strain V117b |
| A-157 | Fluopyram | Trichoderma asperellum strain SKT-1 |
| A-158 | Fluopyram | Trichoderma atroviride strain LC52 |
| A-159 | Fluopyram | Trichoderma harzianum strain T-22 |
| A-160 | Fluopyram | Trichoderma harzianum strain TH-35 |
| A-161 | Fluopyram | Trichoderma harzianum strain T-39 |
| A-162 | Fluopyram | a mixture of Trichoderma harzianum and |
| | | Trichoderma viride |
| A-163 | Fluopyram | a mixture of Trichoderma harzianum strain |
| | | ICC012 and T. viride strain ICC080 |
| A-164 | Fluopyram | a mixture of Trichoderma polysporum and |
| | | Trichoderma harzianum |
| A-165 | Fluopyram | Trichoderma stromaticum |
| A-166 | Fluopyram | Trichoderma virens strain GL-21 |
| A-167 | Fluopyram | Trichoderma viride |
| A-168 | Fluopyram | Trichoderma viride strain TV1 |
| A-169 | Isopyrazam | coumethoxystrobin |
| A-170 | Isopyrazam | coumoxystrobin |
| A-171 | Isopyrazam | pyrametostrobin |
| A-172 | Isopyrazam | pyraoxystrobin |
| A-173 | Isopyrazam | N-methoxy-[2-(3,5,6-trichloro-pyridin-2- |
| | | yloxymethyl)-phenyl]-carbamic acid methyl |
| | | ester |
| A-174 | Isopyrazam | 2-[2-(5-cyano-2-methyl-phenoxymethyl)- |
| | | phenyl]-3-methoxy-acrylic acid methyl |
| | | ester |
| A-175 | Isopyrazam | 3-methoxy-2-{2-[2-methoxy-5- |
| | | (methoxyimino-methyl)-phenoxymethyl]- |
| | | phenyl}-acrylic acid methyl ester |
| A-176 | Isopyrazam | dichlobutrazole |
| A-177 | Isopyrazam | etaconazole |
| A-178 | Isopyrazam | quinconazole |
| A-179 | Isopyrazam | clazafenone |
| A-180 | Isopyrazam | ethaboxam |
| A-181 | Isopyrazam | flutianil |
| A-182 | Isopyrazam | pyrimorph |
| A-183 | Isopyrazam | tebufloquin |
| A-184 | Isopyrazam | 2-(4-chloro-phenyl)-N-[4-(3,4-dimethoxy- |
| | | phenyl)-isoxazol-5-yl]-2-prop-2-ynyloxy- |
| | | acetamide (IIa) |
| A-185 | Isopyrazam | 2-{1-[2-(5-methyl-3-trifluoromethyl-pyrazol- |
| | | 1-yl)-acetyl]-piperidin-4-yl}-thiazole-4- |
| | | carboxylic acid methyl-(R)-1,2,3,4- |
| | | tetrahydro-naphthalen-1-yl-amide (IIb) |
| A-186 | Isopyrazam | 4-cyclopropyl-[1,2,3]thiadiazole-5- |
| | | carboxylic acid 4-chloro-benzyl ester (IIc) |
| A-187 | Isopyrazam | 4-cyclopropyl-[1,2,3]thiadiazole-5- |
| | | carboxylic acid (2,4-dimethoxy-phenyl)- |
| | | amide (IId) |
| A-188 | Isopyrazam | 1-(2,4-dichloro-phenyl)-2-imidazol-1-yl- |
| | | ethanone O-allyl-oxime (IIe) |
| A-189 | Isopyrazam | 5-chloro-1-(4,6-dimethoxy-pyrimidin-2-yl)- |
| | | 2-methyl-1H-benzoimidazole (IIf) |
| A-190 | Isopyrazam | 3-(2,3-dimethyl-5-p-tolyl-isoxazolidin-3-yl)- |
| | | pyridine (IIg) |
| A-191 | Isopyrazam | cocamidopropyl-betaine |
| A-192 | Isopyrazam | Ulocladium oudemansii, |
| A-193 | Isopyrazam | chitosan |
| A-194 | Isopyrazam | Trichoderma atroviride |
| A-195 | Isopyrazam | Ampelomyces quisqualis |
| A-196 | Isopyrazam | Aspergillus flavus |
| A-197 | Isopyrazam | Aureobasidium pullulans |
| A-198 | Isopyrazam | Bacillus subtilis var. Amyloliquefaciens |
| | | FZB24 |
| A-199 | Isopyrazam | Candida oleophila strain 1-182 |
| A-200 | Isopyrazam | Candida saitoana |
| A-201 | Isopyrazam | Clonostachys rosea f. catenulate |
| A-202 | Isopyrazam | Coniothyrium minitans |
| A-203 | Isopyrazam | Cryphonectria parasitica |
| A-204 | Isopyrazam | Cryptococcus albidus |
| A-205 | Isopyrazam | Fusarium oxysporum |
| A-206 | Isopyrazam | Metschnikowia fructicola |
| A-207 | Isopyrazam | Microdochium dimerum |
| A-208 | Isopyrazam | Phlebiopsis gigantea |
| A-209 | Isopyrazam | Pseudozyma flocculosa |
| A-210 | Isopyrazam | Pythium oligandrum |
| A-211 | Isopyrazam | Reynoutria sachlinensis |
| A-212 | Isopyrazam | Talaromyces flavus strain V117b |
| A-213 | Isopyrazam | Trichoderma asperellum strain SKT-1 |
| A-214 | Isopyrazam | Trichoderma atroviride strain LC52 |
| A-215 | Isopyrazam | Trichoderma harzianum strain T-22 |
| A-216 | Isopyrazam | Trichoderma harzianum strain TH-35 |
| A-217 | Isopyrazam | Trichoderma harzianum strain T-39 |
| A-218 | Isopyrazam | a mixture of Trichoderma harzianum and |
| | | Trichoderma viride |
| A-219 | Isopyrazam | a mixture of Trichoderma harzianum strain |
| | | ICC012 and T. viride strain ICC080 |
| A-220 | Isopyrazam | a mixture of Trichoderma polysporum and |
| | | Trichoderma harzianum |
| A-221 | Isopyrazam | Trichoderma stromaticum |
| A-222 | Isopyrazam | Trichoderma virens strain GL-21 |
| A-223 | Isopyrazam | Trichoderma viride |
| A-224 | Isopyrazam | Trichoderma viride strain TV1 |
| A-225 | Sedaxane | coumethoxystrobin |
| A-226 | Sedaxane | coumoxystrobin |
| A-227 | Sedaxane | pyrametostrobin |
| A-228 | Sedaxane | pyraoxystrobin |
| A-229 | Sedaxane | N-methoxy-[2-(3,5,6-trichloro-pyridin-2- |
| | | yloxymethyl)-phenyl]-carbamic acid methyl |
| | | ester |
| A-230 | Sedaxane | 2-[2-(5-cyano-2-methyl-phenoxymethyl)- |
| | | phenyl]-3-methoxy-acrylic acid methyl |
| | | ester |
| A-231 | Sedaxane | 3-methoxy-2-{2-[2-methoxy-5- |
| | | (methoxyimino-methyl)-phenoxymethyl]- |
| | | phenyl}-acrylic acid methyl ester |
| A-232 | Sedaxane | dichlobutrazole |
| A-233 | Sedaxane | etaconazole |
| A-234 | Sedaxane | quinconazole |
| A-235 | Sedaxane | clazafenone |
| A-236 | Sedaxane | ethaboxam |
| A-237 | Sedaxane | flutianil |
| A-238 | Sedaxane | pyrimorph |
| A-239 | Sedaxane | tebufloquin |
| A-240 | Sedaxane | 2-(4-chloro-phenyl)-N-[4-(3,4-dimethoxy- |
| | | phenyl)-isoxazol-5-yl]-2-prop-2-ynyloxy- |
| | | acetamide (IIa) |
| A-241 | Sedaxane | 2-{1-[2-(5-methyl-3-trifluoromethyl-pyrazol- |
| | | 1-yl)-acetyl]-piperidin-4-yl}-thiazole-4- |
| | | carboxylic acid methyl-(R)-1,2,3,4- |
| | | tetrahydro-naphthalen-1-yl-amide (IIb) |
| A-242 | Sedaxane | 4-cyclopropyl-[1,2,3]thiadiazole-5- |
| | | carboxylic acid 4-chloro-benzyl ester (IIc) |
| A-243 | Sedaxane | 4-cyclopropyl-[1,2,3]thiadiazole-5- |
| | | carboxylic acid (2,4-dimethoxy-phenyl)- |
| | | amide (IId) |
| A-244 | Sedaxane | 1-(2,4-dichloro-phenyl)-2-imidazol-1-yl- |
| | | ethanone O-allyl-oxime (IIe) |
| A-245 | Sedaxane | 5-chloro-1-(4,6-dimethoxy-pyrimidin-2-yl)- |
| | | 2-methyl-1H-benzoimidazole (IIf) |
| A-246 | Sedaxane | 3-(2,3-dimethyl-5-p-tolyl-isoxazolidin-3-yl)- |
| | | pyridine (IIg) |
| A-247 | Sedaxane | cocamidopropyl-betaine |
| A-248 | Sedaxane | Ulocladium oudemansii, |
| A-249 | Sedaxane | chitosan |
| A-250 | Sedaxane | Trichoderma atroviride |
| A-251 | Sedaxane | Ampelomyces quisqualis |
| A-252 | Sedaxane | Aspergillus flavus |
| A-253 | Sedaxane | Aureobasidium pullulans |
| A-254 | Sedaxane | Bacillus subtilis var. Amyloliquefaciens |
| | | FZB24 |
| A-255 | Sedaxane | Candida oleophila strain 1-182 |
| A-256 | Sedaxane | Candida saitoana |
| A-257 | Sedaxane | Clonostachys rosea f. catenulate |
| A-258 | Sedaxane | Coniothyrium minitans |
| A-259 | Sedaxane | Cryphonectria parasitica |
| A-260 | Sedaxane | Cryptococcus albidus |
| A-261 | Sedaxane | Fusarium oxysporum |
| A-262 | Sedaxane | Metschnikowia fructicola |
| A-263 | Sedaxane | Microdochium dimerum |
| A-264 | Sedaxane | Phlebiopsis gigantea |
| A-265 | Sedaxane | Pseudozyma flocculosa |
| A-266 | Sedaxane | Pythium oligandrum |
| A-267 | Sedaxane | Reynoutria sachlinensis |
| A-268 | Sedaxane | Talaromyces flavus strain V117b |
| A-269 | Sedaxane | Trichoderma asperellum strain SKT-1 |
| A-270 | Sedaxane | Trichoderma atroviride strain LC52 |
| A-271 | Sedaxane | Trichoderma harzianum strain T-22 |
| A-272 | Sedaxane | Trichoderma harzianum strain TH-35 |
| A-273 | Sedaxane | Trichoderma harzianum strain T-39 |
| A-274 | Sedaxane | a mixture of Trichoderma harzianum and |
| | | Trichoderma viride |
| A-275 | Sedaxane | a mixture of Trichoderma harzianum strain |
| | | ICC012 and T. viride strain ICC080 |
| A-276 | Sedaxane | a mixture of Trichoderma polysporum and |
| | | Trichoderma harzianum |
| A-277 | Sedaxane | Trichoderma stromaticum |
| A-278 | Sedaxane | Trichoderma virens strain GL-21 |
| A-279 | Sedaxane | Trichoderma viride |
| A-280 | Sedaxane | Trichoderma viride strain TV1 |
| A-281 | Penflufen | coumethoxystrobin |
| A-282 | Penflufen | coumoxystrobin |
| A-283 | Penflufen | pyrametostrobin |
| A-284 | Penflufen | pyraoxystrobin |
| A-285 | Penflufen | N-methoxy-[2-(3,5,6-trichloro-pyridin-2- |
| | | yloxymethyl)-phenyl]-carbamic acid methyl |
| | | ester |
| A-286 | Penflufen | 2-[2-(5-cyano-2-methyl-phenoxymethyl)- |
| | | phenyl]-3-methoxy-acrylic acid methyl |
| | | ester |
| A-287 | Penflufen | 3-methoxy-2-{2-[2-methoxy-5- |
| | | (methoxyimino-methyl)-phenoxymethyl]- |
| | | phenyl}-acrylic acid methyl ester |
| A-288 | Penflufen | dichlobutrazole |
| A-289 | Penflufen | etaconazole |
| A-290 | Penflufen | quinconazole |
| A-291 | Penflufen | clazafenone |
| A-292 | Penflufen | ethaboxam |
| A-293 | Penflufen | flutianil |
| A-294 | Penflufen | pyrimorph |
| A-295 | Penflufen | tebufloquin |
| A-296 | Penflufen | 2-(4-chloro-phenyl)-N-[4-(3,4-dimethoxy- |
| | | phenyl)-isoxazol-5-yl]-2-prop-2-ynyloxy- |
| | | acetamide (IIa) |
| A-297 | Penflufen | 2-{1-[2-(5-methyl-3-trifluoromethyl-pyrazol- |
| | | 1-yl)-acetyl]-piperidin-4-yl}-thiazole-4- |
| | | carboxylic acid methyl-(R)-1,2,3,4- |
| | | tetrahydro-naphthalen-1-yl-amide (IIb) |
| A-298 | Penflufen | 4-cyclopropyl-[1,2,3]thiadiazole-5- |
| | | carboxylic acid 4-chloro-benzyl ester (IIc) |
| A-299 | Penflufen | 4-cyclopropyl-[1,2,3]thiadiazole-5- |
| | | carboxylic acid (2,4-dimethoxy-phenyl)- |
| | | amide (IId) |
| A-300 | Penflufen | 1-(2,4-dichloro-phenyl)-2-imidazol-1-yl- |
| | | ethanone O-allyl-oxime (IIe) |
| A-301 | Penflufen | 5-chloro-1-(4,6-dimethoxy-pyrimidin-2-yl)- |
| | | 2-methyl-1H-benzoimidazole (IIf) |
| A-302 | Penflufen | 3-(2,3-dimethyl-5-p-tolyl-isoxazolidin-3-yl)- |
| | | pyridine (IIg) |
| A-303 | Penflufen | cocamidopropyl-betaine |
| A-304 | Penflufen | Ulocladium oudemansii, |
| A-305 | Penflufen | chitosan |
| A-306 | Penflufen | Trichoderma atroviride |
| A-307 | Penflufen | Ampelomyces quisqualis |
| A-308 | Penflufen | Aspergillus flavus |
| A-309 | Penflufen | Aureobasidium pullulans |
| A-310 | Penflufen | Bacillus subtilis var. Amyloliquefaciens |
| | | FZB24 |
| A-311 | Penflufen | Candida oleophila strain I-182 |
| A-312 | Penflufen | Candida saitoana |
| A-313 | Penflufen | Clonostachys rosea f. catenulate |
| A-314 | Penflufen | Coniothyrium minitans |
| A-315 | Penflufen | Cryphonectria parasitica |
| A-316 | Penflufen | Cryptococcus albidus |
| A-317 | Penflufen | Fusarium oxysporum |
| A-318 | Penflufen | Metschnikowia fructicola |
| A-319 | Penflufen | Microdochium dimerum |
| A-320 | Penflufen | Phlebiopsis gigantea |
| A-321 | Penflufen | Pseudozyma flocculosa |
| A-322 | Penflufen | Pythium oligandrum |
| A-323 | Penflufen | Reynoutria sachlinensis |
| A-324 | Penflufen | Talaromyces flavus strain V117b |
| A-325 | Penflufen | Trichoderma asperellum strain SKT-1 |
| A-326 | Penflufen | Trichoderma atroviride strain LC52 |
| A-327 | Penflufen | Trichoderma harzianum strain T-22 |
| A-328 | Penflufen | Trichoderma harzianum strain TH-35 |
| A-329 | Penflufen | Trichoderma harzianum strain T-39 |
| A-330 | Penflufen | a mixture of Trichoderma harzianum and |
| | | Trichoderma viride |
| A-331 | Penflufen | a mixture of Trichoderma harzianum strain |
| | | ICC012 and T. viride strain ICC080 |
| A-332 | Penflufen | a mixture of Trichoderma polysporum and |
| | | Trichoderma harzianum |
| A-333 | Penflufen | Trichoderma stromaticum |
| A-334 | Penflufen | Trichoderma virens strain GL-21 |
| A-335 | Penflufen | Trichoderma viride |
| A-336 | Penflufen | Trichoderma viride strain TV1 |
| A-337 | Penthiopyrad | coumethoxystrobin |
| A-338 | Penthiopyrad | coumoxystrobin |
| A-339 | Penthiopyrad | pyrametostrobin |
| A-340 | Penthiopyrad | pyraoxystrobin |
| A-341 | Penthiopyrad | N-methoxy-[2-(3,5,6-trichloro-pyridin-2- |
| | | yloxymethyl)-phenyl]-carbamic acid methyl |
| | | ester |
| A-342 | Penthiopyrad | 2-[2-(5-cyano-2-methyl-phenoxymethyl)- |
| | | phenyl]-3-methoxy-acrylic acid methyl |
| | | ester |
| A-343 | Penthiopyrad | 3-methoxy-2-{2-[2-methoxy-5- |
| | | (methoxyimino-methyl)-phenoxymethyl]- |
| | | phenyl}-acrylic acid methyl ester |
| A-344 | Penthiopyrad | dichlobutrazole |
| A-345 | Penthiopyrad | etaconazole |
| A-346 | Penthiopyrad | quinconazole |
| A-347 | Penthiopyrad | clazafenone |
| A-348 | Penthiopyrad | ethaboxam |
| A-349 | Penthiopyrad | flutianil |
| A-350 | Penthiopyrad | pyrimorph |
| A-351 | Penthiopyrad | tebufloquin |
| A-352 | Penthiopyrad | 2-(4-chloro-phenyl)-N-[4-(3,4-dimethoxy- |
| | | phenyl)-isoxazol-5-yl]-2-prop-2-ynyloxy- |
| | | acetamide (IIa) |
| | | 2-{1-[2-(5-methyl-3-trifluoromethyl-pyrazol- |
| A-353 | Penthiopyrad | 1-yl)-acetyl]-piperidin-4-yl}-thiazole-4- |
| | | carboxylic acid methyl-(R)-1,2,3,4- |
| | | tetrahydro-naphthalen-1-yl-amide (IIb) |
| A-354 | Penthiopyrad | 4-cyclopropyl-[1,2,3]thiadiazole-5- |
| | | carboxylic acid 4-chloro-benzyl ester (IIc) |
| A-355 | Penthiopyrad | 4-cyclopropyl-[1,2,3]thiadiazole-5- |
| | | carboxylic acid (2,4-dimethoxy-phenyl)- |
| | | amide (IId) |
| A-356 | Penthiopyrad | 1-(2,4-dichloro-phenyl)-2-imidazol-1-yl- |
| | | ethanone O-allyl-oxime (IIe) |
| A-357 | Penthiopyrad | 5-chloro-1-(4,6-dimethoxy-pyrimidin-2-yl)- |
| | | 2-methyl-1H-benzoimidazole (IIf) |
| A-358 | Penthiopyrad | 3-(2,3-dimethyl-5-p-tolyl-isoxazolidin-3-yl)- |
| | | pyridine (IIg) |
| A-359 | Penthiopyrad | cocamidopropyl-betaine |
| A-360 | Penthiopyrad | Ulocladium oudemansii, |
| A-361 | Penthiopyrad | chitosan |
| A-362 | Penthiopyrad | Trichoderma atroviride |
| A-363 | Penthiopyrad | Ampelomyces quisqualis |
| A-364 | Penthiopyrad | Aspergillus flavus |
| A-365 | Penthiopyrad | Aureobasidium pullulans |
| A-366 | Penthiopyrad | Bacillus subtilis var. Amyloliquefaciens |
| | | FZB24 |
| A-367 | Penthiopyrad | Candida oleophila strain I-182 |
| A-368 | Penthiopyrad | Candida saitoana |
| A-369 | Penthiopyrad | Clonostachys rosea f. catenulate |
| A-370 | Penthiopyrad | Coniothyrium minitans |
| A-371 | Penthiopyrad | Cryphonectria parasitica |
| A-372 | Penthiopyrad | Cryptococcus albidus |
| A-373 | Penthiopyrad | Fusarium oxysporum |
| A-374 | Penthiopyrad | Metschnikowia fructicola |
| A-375 | Penthiopyrad | Microdochium dimerum |
| A-376 | Penthiopyrad | Phlebiopsis gigantea |
| A-377 | Penthiopyrad | Pseudozyma flocculosa |
| A-378 | Penthiopyrad | Pythium oligandrum |
| A-379 | Penthiopyrad | Reynoutria sachlinensis |
| A-380 | Penthiopyrad | Talaromyces flavus strain V117b |
| A-381 | Penthiopyrad | Trichoderma asperellum strain SKT-1 |
| A-382 | Penthiopyrad | Trichoderma atroviride strain LC52 |
| A-383 | Penthiopyrad | Trichoderma harzianum strain T-22 |
| A-384 | Penthiopyrad | Trichoderma harzianum strain TH-35 |
| A-385 | Penthiopyrad | Trichoderma harzianum strain T-39 |
| A-386 | Penthiopyrad | a mixture of Trichoderma harzianum and |
| | | Trichoderma viride |
| A-387 | Penthiopyrad | a mixture of Trichoderma harzianum strain |
| | | ICC012 and T. viride strain ICC080 |
| A-388 | Penthiopyrad | a mixture of Trichoderma polysporum and |
| | | Trichoderma harzianum |
| A-389 | Penthiopyrad | Trichoderma stromaticum |
| A-390 | Penthiopyrad | Trichoderma virens strain GL-21 |
| A-391 | Penthiopyrad | Trichoderma viride |
| A-392 | Penthiopyrad | Trichoderma viride strain TV1 |

*3-difluoromethyl-1-methyl-1H-pyrazole-4-carboxylic acid (3′,4′,5′-trifluoro-biphenyl-2-yl)-amide

Among these, preference is given to following compositions: A-11, A-12, A-13, A-14, A-15, A-16, A-17, A-21, A-24, A-25, A-26, A-67, A-68, A-69, A-70, A-71, A-72, A-73, A-77, A-80, A-81, A-82, A-123, A-124, A-125, A-126, A-127, A-128, A-129, A-133, A-136, A-137, A-138, A-179, A-180, A-181, A-182, A-183, A-184, A-185, A-189, A-192, A-193, A-194, A-347, A-348, A-349, A-350, A-351, A-352, A-353, A-357, A-360, A-361 and A-362.

More preference is given to following compositions: A-11, A-12, A-13, A-14, A-16, A-17, A-24, A-25, A-26, A-67, A-68, A-69, A-70, A-72, A-73, A-80, A-81, A-82, A-179, A-180, A-181, A-182, A-184, A-185, A-192, A-193 and A-194.

The composition according to the invention is suitable as a fungicide. It is distinguished by an outstanding effectiveness against a broad spectrum of phytopathogenic fungi, including soil-borne fungi, which derive especially from the classes of the Plasmodiophoromycetes, Peronosporomycetes (syn. Oomycetes), Chytridiomycetes, Zygomycetes, Ascomycetes, Basidiomycetes and Deuteromycetes (syn. Fungi imperfecti). Some are systemically effective and they can be used in crop protection as foliar fungicides, fungicides for seed dressing and soil fungicides. Moreover, they are suitable for controlling harmful fungi, which inter alia occur in wood or roots of plants.

The compositions according to the invention are particularly important in the control of a multitude of phytopathogenic fungi on various cultivated plants, such as cereals, e.g. wheat, rye, barley, triticale, oats or rice; beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; sweet leaf (also called Stevia); natural rubber plants or ornamental and forestry plants, such as flowers, shrubs, broad-leaved trees or evergreens, e.g. conifers; and on the plant propagation material, such as seeds, and the crop material of these plants.

Preferably, compositions of the invention are used for controlling a multitude of fungi on field crops, such as potatoes, sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

As already explained, the term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be trans-planted after germination or after emergence from soil. These young plants may also be protected before transplantation by a total or partial treatment by immersion or pouring.

Preferably, treatment of plant propagation materials with the compositions of the invention is used for controlling a multitude of fungi on cereals, such as wheat, rye, barley and oats; rice, corn, cotton and soybeans.

The term “cultivated plants” is to be understood as including plants which have been modified by breeding, mutagenesis or genetic engineering including but not limited to agricultural biotech products on the market or in development (cf. http://www.bio.org/speeches/pubs/er/agri_products.asp). Genetically modified plants are plants whose genetic material has been modified by the use of recombinant DNA techniques in such a way that under natural circumstances they cannot readily be obtained by cross breeding, mutations or natural recombination. Typically, one or more genes have been integrated into the genetic material of a genetically modified plant in order to improve certain properties of the plant. Such genetic modifications also include, but are not limited to, targeted post-translational modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides, such as auxin herbicides such as dicamba or 2,4-D; bleacher herbicides such as hydroxylphenylpyruvate dioxygenase (HPPD) inhibitors or phytoene desaturase (PDS) inhibittors; acetolactate synthase (ALS) inhibitors such as sulfonyl ureas or imidazolinones; enolpyruvylshikimate-3-phosphate synthase (EPSPS) inhibitors, such as glyphosate; glutamine synthetase (GS) inhibitors such as glufosinate; protoporphyrinogen-IX oxidase inhibitors; lipid biosynthesis inhibitors such as acetyl CoA carboxylase (ACCase) inhibitors; or oxynil (i.e. bromoxynil or ioxynil) herbicides as a result of conventional methods of breeding or genetic engineering. Furthermore, plants have been made resistant to multiple classes of herbicides through multiple genetic modifications, such as resistance to both glyphosate and glufosinate or to both glyphosate and an herbicide from another class such as ALS inhibitors, HPPD inhibitors, auxin herbicides, or ACCase inhibitors. These herbicide resistance technologies are e.g. described in Pest Managem. Sci. 61, 2005, 246; 61, 2005, 258; 61, 2005, 277; 61, 2005, 269; 61, 2005, 286; 64, 2008, 326; 64, 2008, 332; Weed Sci. 57, 2009, 108; Austral. J. Agricult. Res. 58, 2007, 708; Science 316, 2007, 1185; and references quoted therein. Several cultivated plants have been rendered tolerant to herbicides by conventional methods of breeding (mutagenesis), e.g. Clearfield® summer rape (Canola, BASF SE, Germany) being tolerant to imidazolinones, e.g. imazamox, or ExpressSun® sunflowers (DuPont, USA) being tolerant to sulfonyl ureas, e.g. tribenuron. Genetic engineering methods have been used to render cultivated plants such as soybean, cotton, corn, beets and rape, tolerant to herbicides such as glyphosate and glufosinate, some of which are commercially available under the trade names RoundupReady® (glyphosate-tolerant, Monsanto, U.S.A.), Cultivance® (imidazolinone tolerant, BASF SE, Germany) and LibertyLink® (glufosinate-tolerant, Bayer CropScience, Germany).

Furthermore, plants are also covered that, by the use of recombinant DNA techniques, are capable to synthesize one or more insecticidal proteins, especially those known from the bacterial genus Bacillus, particularly from Bacillus thuringiensis, such as δ-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the CrylAb toxin), YieldGard® Plus (corn cultivars producing Cry1Ab and Cry3Bb1 toxins), Starlink® (corn cultivars producing the Cry9c toxin), Her-culex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); BtXtra®, NatureGard®, KnockOut®, BiteGard®, Protecta®, Bt11 (e.g. Agrisure® CB) and Bt176 from Syngenta Seeds SAS, France, (corn cultivars producing the CrylAb toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that, by the use of recombinant DNA techniques, are capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392 225), plant disease resistance genes (e.g. potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that, by the use of recombinant DNA techniques, are capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that, by the use of recombinant DNA techniques, contain a modified amount of substances of content or new substances of content, specifically to improve human or animal nutrition, e.g. oil crops that produce healthpromoting long-chain omega-3 fatty acids or unsaturated omega-9 fatty acids (e.g. Nexera® rape, DOW Agro Sciences, Canada).

Furthermore, plants are also covered that, by the use of recombinant DNA techniques, a modified amount of substances of content or new substances of content, specifically to improve raw material production, e.g. potatoes that produce increased amounts of amylopectin (e.g. Amflora® potato, BASF SE, Germany).

The compositions of the invention are particularly suitable for controlling the following plant diseases:

Albugo spp. (white rust) on ornamentals, vegetables (e.g. A. candida) and sunflowers (e.g. A. tragopogonis); Alternaria spp. (Alternaria leaf spot) on vegetables, rape (A. brassicola or brassicae), sugar beets (A. tenuis), fruits, rice, soybeans, potatoes (e.g. A. solani or A. alternata), tomatoes (e.g. A. solani or A. alternata) and wheat; Aphanomyces spp. on sugar beets and vegetables; Ascochyta spp. on cereals and vegetables, e.g. A. tritici(anthracnose) on wheat and A. hordei on barley; Bipolaris and Drechslera spp. (teleomorph: Cochliobolus spp.), e.g. Southern leaf blight (D. maydis) or Northern leaf blight (B. zeicola) on corn, e.g. spot blotch (B. sorokiniana) on cereals and e.g. B. oryzae on rice and turfs; Blumeria (formerly Erysiphe) graminis (powdery mildew) on cereals (e.g. on wheat or barley); Botrytis cinerea (teleomorph: Botryotinia fuckeliana: grey mold) on fruits and berries (e.g. strawberries), vegetables (e.g. lettuce, carrots, celery and cabbages), rape, flowers, vines, forestry plants and wheat; Bremia lactucae (downy mildew) on lettuce; Ceratocystis (syn. Ophiostoma) spp. (rot or wilt) on broad-leaved trees and evergreens, e.g. C. ulmi (Dutch elm disease) on elms; Cercospora spp. (Cercospora leaf spots) on corn (e.g. Gray leaf spot: C. zeae-maydis), rice, sugar beets (e.g. C. beticola), sugar cane, vegetables, coffee, soybeans (e.g. C. sojina or C. kikuchii) and rice; Cladosporium spp. on tomatoes (e.g. C. fulvum: leaf mold) and cereals, e.g. C. herbarum (black ear) on wheat; Claviceps purpurea (ergot) on cereals; Cochgobolus (anamorph: Helminthosporium of Bipolaris) spp. (leaf spots) on corn (C. carbonum), cereals (e.g. C. sativus, anamorph: B. sorokiniana) and rice (e.g. C. miyabeanus, anamorph: H. oryzae); Colletotrichum (teleomorph: Glomerella) spp. (anthracnose) on cotton (e.g. C. gossypii), corn (e.g. C. graminicola: Anthracnose stalk rot), soft fruits, potatoes (e.g. C. coccodes: black dot), beans (e.g. C. lindemuthianum) and soybeans (e.g. C. truncatum or C. gloeosporioides); Corticium spp., e.g. C. sasakii blight) on rice; Corynespora cassiicola (leaf spots) on soybeans and ornamentals; Cycloconium spp., e.g. C. oleaginum on olive trees; Cylindrocarpon spp. (e.g. fruit tree canker or young vine decline, teleomorph: Nectria or Neonectria spp.) on fruit trees, vines (e.g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e.g. D. phaseolorum (damping off) on soybeans; Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtusa; Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on sugar beets (E. betae), vegetables (e.g. E. pisi), such as cucurbits (e.g. E. cichoracearum), cabbages, rape (e.g. E. cruciferarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e.g. E. turcicum); Fusarium (teleomorph: Gibberella) spp. (wilt, root or stem rot) on various plants, such as F. graminearum or F. culmorum (root rot, scab or head blight) on cereals (e.g. wheat or barley), F. oxysporum on tomatoes, F. solani on soybeans and F. verticilliodes on corn; Gaeumannomyces graminis (take-all) on cereals (e.g. wheat or barley) and corn; Gibberella spp. on cereals (e.g. G. zeae) and rice (e.g. G. fujikuroi: Bakanae disease); Glomerella cingulata on vines, pome fruits and other plants and G. gossypii on cotton; Grainstaining complex on rice; Guignardia bidwellii (black rot) on vines; Gymnosporangium spp. on rosaceous plants and junipers, e.g. G. sabinae (rust) on pears; Helminthosporium spp. (syn. Drechslera, teleomorph: Cochliobolus) on corn, cereals and rice; Hemileia spp., e.g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e.g. wheat or barley); Microsphaera diffusa (powdery mildew) on soybeans; Monilinia spp., e.g. M. laxa, M. fructicola and M. fructigena (bloom and twig blight, brown rot) on stone fruits and other rosaceous plants; Mycosphaerella spp. on cereals, bananas, soft fruits and ground nuts, such as e.g. M. graminicola (anamorph: Septoria tritici, Septoria blotch) on wheat or M. fijensis (black Sigatoka disease) on bananas; Peronospora spp. (downy mildew) on cabbage (e.g. P. brassicae), rape (e.g. P. parasitica), onions (e.g. P. destructor), tobacco (P. tabacina) and soybeans (e.g. P. manshurica); Phakopsora pachyrhizi and P. meibomiae (soybean rust) on soybeans; Phialophora spp. e.g. on vines (e.g. P. tracheiphila and P. tetraspora) and soybeans (e.g. P. gregata: stem rot); Phoma lingam (root and stem rot) on rape and cabbage and P. betae (root rot, leaf spot and damping-off) on sugar beets; Phomopsis spp. on sunflowers, vines (e.g. P. viticola: can and leaf spot) and soybeans (e.g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e.g. P. capsici), soybeans (e.g. P. megasperma, syn. P. sojae), potatoes and tomatoes (e.g. P. infestans: late blight) and broad-leaved trees (e.g. P. ramorum: sudden oak death); Plasmodiophora brassicae (club root) on cabbage, rape, radish and other plants; Plasmopara spp., e.g. P. viticola (grapevine downy mildew) on vines and P. halstedii on sunflowers; Podosphaera spp. (powdery mildew) on rosaceous plants, hop, pome and soft fruits, e.g. P. leucotricha on apples; Polymyxa spp., e.g. on cereals, such as barley and wheat (P. graminis) and sugar beets (P. betae) and thereby transmitted viral diseases; Pseudocercosporella herpotrichoides (eyespot, teleomorph: Tapesia yallundae) on cereals, e.g. wheat or barley; Pseudoperonospora (downy mildew) on various plants, e.g. P. cubensis on cucurbits or P. humili on hop; Pseudopezicula tracheiphila (red fire disease or, rotbrenner, anamorph: Phialophora) on vines; Puccinia spp. (rusts) on various plants, e.g. P. triticina (brown or leaf rust), P. striiformis (stripe or yellow rust), P. hordei (dwarf rust), P. graminis (stem or black rust) or P. recondita (brown or leaf rust) on cereals, such as e.g. wheat, barley or rye, P. kuehnii (orange rust) on sugar cane and P. asparagi on asparagus; Pyrenophora (anamorph: Drechslera) tritici-repentis (tan spot) on wheat or P. teres (net blotch) on barley; Pyricularia spp., e.g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e.g. P. ultimum or P. aphanidermatum); Ramularia spp., e.g. R. collo-cygni (Ramularia leaf spots, Physiological leaf spots) on barley and R. beticola on sugar beets; Rhizoctoma spp. on cotton, rice, potatoes, turf, corn, rape, potatoes, sugar beets, vegetables and various other plants, e.g. R. solani (root and stem rot) on soybeans, R. so/an/(sheath blight) on rice or R. cereags (Rhizoctonia spring blight) on wheat or barley; Rhizopus stolonifer (black mold, soft rot) on strawberries, carrots, cabbage, vines and tomatoes; Rhynchosporium secalis (scald) on barley, rye and triticale; Sarocladium oryzae and S. attenuatum (sheath rot) on rice; Sclerotinia spp. (stem rot or white mold) on vegetables and field crops, such as rape, sunflowers (e.g. S. sclerotiorum) and soybeans (e.g. S. rolfsii or S. sclerotiorum); Septoria spp. on various plants, e.g. S. glycines (brown spot) on soybeans, S. tritici (Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setospaeria spp. (leaf blight) on corn (e.g. S. turcicum, syn. Helminthosporium turcicum) and turf; Sphacelothecaspp. (smut) on corn, (e.g. S. rethana: head smut), sorghum and sugar cane; Sphaerotheca fuliginea (powdery mildew) on cucurbits; Spongospora subterranea (powdery scab) on potatoes and thereby transmitted viral diseases; Stagonospora spp. on cereals, e.g. S. nodorum (Stagonospora blotch, teleomorph: Leptosphaeria [syn. Phaeosphaeria] nodorum) on wheat; Synchytrium endobioticum on potatoes (potato wart disease); Taphrina spp., e.g. T. deformans (leaf curl disease) on peaches and T. pruni (plum pocket) on plums; Thielaviopsis spp. (black root rot) on tobacco, pome fruits, vegetables, soybeans and cotton, e.g. T. basicola (syn. Chalara elegans); Tilletia spp. (common bunt or stinking smut) on cereals, such as e.g. T. tritici (syn. T. caries, wheat bunt) and T. controversa (dwarf bunt) on wheat; Typhula incarnata (grey snow mold) on barley or wheat; Urocystis spp., e.g. U. occulta (stem smut) on rye; Uromyces spp. (rust) on vegetables, such as beans (e.g. U. appendiculatus, syn. U. phaseoli) and sugar beets (e.g. U. betae); Ustilago spp. (loose smut) on cereals (e.g. U. nuda and U. avaenae), corn (e.g. U. maydis: corn smut) and sugar cane; Venturia spp. (scab) on apples (e.g. V inaequalis) and pears; and Verticillium spp. (wilt) on various plants, such as fruits and ornamentals, vines, soft fruits, vegetables and field crops, e.g. V. dahliae on strawberries, rape, potatoes and tomatoes.

The compounds I and compositions thereof, respectively, are also suitable for controlling harmful fungi in the protection of stored products or harvest and in the protection of materials. The term “protection of materials” is to be understood to denote the protection of technical and non-living materials, such as adhesives, glues, wood, paper and paperboard, textiles, leather, paint dispersions, plastics, cooling lubricants, fiber or fabrics, against the infestation and destruction by harmful microorganisms, such as fungi and bacteria. As to the protection of wood and other materials, the particular attention is paid to the following harmful fungi: Ascomycetes such as Ophiostoma spp., Ceratocystis spp., Aureobasidium pullulans, Sclerophoma spp., Chaetomium spp., Humicola spp., Petnella spp., Trichurus spp.; Basidiomycetes such as Coniophora spp., Coriolus spp., Gloeophyllum spp., Lentinus spp., Pleurotus spp., Poria spp., Serpula spp. and Tyromyces spp., Deuteromycetes such as Aspergillus spp., Cladosporium spp., Penicillium spp., Tfichorma spp., Alternaria spp., Paecilomyces spp. and Zygomycetes such as Mucor spp., and in addition in the protection of stored products and harvest the following yeast fungi are worthy of note: Candida spp. and Saccharomyces cerevisae.

The compositions of the invention may be used for improving the health of a plant. The invention also relates to a method for improving plant health by treating a plant, its propagation material and/or the locus where the plant is growing or is to grow with an effective amount of a composition of the invention.

The term “plant health” is to be understood to denote a condition of the plant and/or its products which is determined by several indicators alone or in combination with each other such as yield (e.g. increased biomass and/or increased content of valuable ingredients), plant vigor (e.g. improved plant growth and/or greener leaves (“greening effect”), quality (e.g. improved content or composition of certain ingredients) and tolerance to abiotic and/or biotic stress. The above identified indicators for the health condition of a plant may be interdependent or may result from each other.

The compounds I and components II and their composition are employed as such or in form of formulated compositions by treating the fungi or the plants, plant propagation materials, such as seeds, soil, surfaces, materials or rooms to be protected from fungal attack with a fungicidally effective amount of the active substances. The application can be carried out both before and after the infection of the plants, plant propagation materials, such as seeds, soil, surfaces, materials or rooms by the fungi.

Plant propagation materials may be treated with compounds I in combination with components II or a composition of the invention prophylactically either at or before planting or transplanting.

The treatment can be made into the seedbox before planting into the field.

The invention also relates to agrochemical compositions comprising a solvent or solid carrier, at least one compound I and at least one component II and to the use for controlling harmful fungi.

An agrochemical composition comprises a fungicidally effective amount of a compound I and a component II. The term “effective amount” denotes an amount of the composition and its active ingredients, which is sufficient for controlling harmful fungi on cultivated plants or in the protection of materials and which does not result in a substantial damage to the treated plants. Such an amount can vary in a broad range and is dependent on various factors, such as the fungal species to be controlled, the treated cultivated plant or material, the climatic conditions and the specific compound I or component II used.

The compounds I, their N-oxides and salts and the components II or their mixture can be converted into customary types of agrochemical compositions, e.g. solutions, ennuisions, suspensions, dusts, powders, pastes and granules. The composition type depends on the particular intended purpose; in each case, it should ensure a fine and uniform distribution of the compound according to the invention.

Examples for agrochemical composition types are suspensions (SC, OD, FS), emulsifiable concentrates (EC), emulsions (EW, EO, ES), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF).

Usually the agrochemical composition types (e.g. SC, OD, FS, EC, WG, SG, WP, SP, SS, WS, GF) are employed diluted. Composition types such as DP, DS, GR, FG, GG and MG are usually used undiluted.

The agrochemical compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineers Handbook, 4th Ed., McGraw-Hill, New York, 1963, p. 8-57 et seq., WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical compositions may also comprise auxiliaries which are customary in agrochemical compositions. The auxiliaries used depend on the particular application form and active substance, respectively.

Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as Nmethylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalenesulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Examples for thickeners (i.e. compounds that impart a modified flowability to compositions, i.e. high viscosity under static conditions and low viscosity during agitation) are polysaccharides and organic and inorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidones, polyvinylacetates, polyvinyl alcohols and cellulose ethers (Tylose®, Shin-Etsu, Japan).

Powders, materials for spreading and dusts can be prepared by mixing or concomitantly grinding the compounds I and, if appropriate, further active substances, with at least one solid carrier.

Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Examples for agrochemical composition types are:

1. Composition types for dilution with water
i) Water-soluble concentrates (SL, LS)

10 parts by weight of an active compound are dissolved in 90 parts by weight of water or in a water-soluble solvent. As an alternative, wetting agents or other auxiliaries are added. The active substance dissolves upon dilution with water. In this way, a composition having a content of 10% by weight of active substance is obtained.

ii) Dispersible concentrates (DC)

20 parts by weight of an active compound are dissolved in 70 parts by weight of cyclohexanone with addition of 10 parts by weight of a dispersant, e.g. polyvinylpyrrolidone. Dilution with water gives a dispersion. The active substance content is 20% by weight.

iii) Emulsifiable concentrates (EC)

15 parts by weight of an active compound are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

### iv) Emulsions (EW, EO, ES)

25 parts by weight of an active compound are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

### v) Suspensions (SC, OD, FS)

In an agitated ball mill, 20 parts by weight of an active compound are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

vi) Water-dispersible granules and water-soluble granules (WG, SG)

50 parts by weight of an active compound are ground finely with addition of 50 parts by weight of dispersants and wetting agents and prepared as water-dispersible or water-soluble granules by means of technical appliances (e.g. extrusion, spray tower, fluidized bed). Dilution with water gives a stable dispersion or solution of the active substance. The composition has an active substance content of 50% by weight.

vii) Water-dispersible powders and water-soluble powders (WP, SP, SS, WS)

75 parts by weight of a compound I according to the invention are ground in a rotorstator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of an active compound are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

2. Composition types to be applied undiluted.
ix) Dustable powders (DP, DS)

5 parts by weight of an active compound are ground finely and mixed intimately with 95 parts by weight of finely divided kaolin. This gives a dustable composition having an active substance content of 5% by weight.

### x) Granules (GR, FG, GG, MG)

0.5 parts by weight of an active compound are ground finely and associated with 99.5 parts by weight of carriers. Current methods are extrusion, spray-drying or the fluidized bed. This gives granules to be applied undiluted having an active substance content of 0.5% by weight.

xi) ULV solutions (UL)

10 parts by weight of an active compound are dissolved in 90 parts by weight of an organic solvent, e.g. xylene. This gives a composition to be applied undiluted having an active substance content of 10% by weight.

The agrochemical compositions generally comprise between 0.01 and 95%, preferably between 0.1 and 90%, most preferably between 0.5 and 90%, by weight of active substances. The active compounds are employed in a purity of from 90% to 100%, preferably from 95% to 100% (according to NMR spectrum).

Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art, and include dressing, coating, pelleting, dusting, soaking and infurrow application methods of the propagation material. In a preferred embodiment, the compounds or the compositions thereof, respectively, are applied on to the plant propagation material by a method such that germination is not induced, e.g. by seed dressing, pelleting, coating and dusting.

In a preferred embodiment, a suspension-type (FS) composition is used for seed treatment. Typcially, a FS composition may comprise 1-800 g/l of active substance, 1-200 g/l surfactant, 0 to 200 g/l antifreezing agent, 0 to 400 g/l of binder, 0 to 200 g/l of a pigment and up to 1 liter of a solvent, preferably water.

The active substances can be used as such or in the form of their formulated compositions, e.g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the active substances according to the invention.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substances, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of active substance.

The active substances may also be used successfully in the ultra-low-volume process (ULV), it being possible to apply compositions comprising over 95% by weight of active substance, or even to apply the active substance without additives.

When employed in plant protection, the (total) amounts of active substances applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha.

In treatment of plant propagation materials such as seeds, e.g. by dusting, coating or drenching seed, (total) amounts of active substance of from 0.1 to 1000 g, preferably from 1 to 1000 g, more preferably from 1 to 100 g and most preferably from 5 to 100 g, per 100 kilogram of plant propagation material (preferably seed) are generally required. When used in the protection of materials or stored products, the (total) amount of active substance applied depends on the kind of application area and on the desired effect. (Total) Amounts customarily applied in the protection of materials are, e.g., 0.001 g to 2 kg, preferably 0.005 g to 1 kg, of active substances per cubic meter of treated material.

Various types of oils, wetters, adjuvants, herbicides, bactericides, insecticides, other fungicides and/or pesticides and/or growth regulators may be added to the active substances or the compositions comprising them, if appropriate not until immediately prior to use (tank mix). These agents can be admixed with the compositions according to the invention in a weight ratio of 1:100 to 100:1, preferably 1:10 to 10:1.

Adjuvants which can be used are in particular organic modified polysiloxanes such as Break Thru S 240®; alcohol alkoxylates such as Atplus 245®, Atplus MBA 1303®, Plurafac LF 300® and Lutensol ON 30®; EO/PO block polymers, e.g. Pluronic RPE 2035® and Genapol B®; alcohol ethoxylates such as Lutensol XP 80®; and dioctyl sulfosuccinate sodium such as Leophen RA®.

The compositions according to the invention can, in the use form as fungicides, also be present together with other active substances, e.g. with herbicides, insecticides, growth regulators, fungicides different from compounds I and components II or else with fertilizers, as pre-mix or, if appropriate, not until immediately prior to use (tank mix).

Mixing the compositions of the invention in the use form as fungicides with other fungicides results in many cases in an expansion of the fungicidal spectrum of activity being obtained or in a prevention of fungicide resistance development. Furthermore, in many cases, synergistic effects are obtained.

The following list of active substances, in conjunction with which the compounds according to the invention can be used, is intended to illustrate the possible combinations but does not limit them:
a) strobilurins
   azoxystrobin, dimoxystrobin, enestroburin, fluoxastrobin, kresoxim-methyl, metominostrobin, orysastrobin, picoxystrobin, pyraclostrobin, pyribencarb, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide;
b) carboxamides
   carboxanilides: benalaxyl, benalaxyl-M, benodanil, bixafen, boscalid, carboxin, fenfuram, fenhexamid, flutolanil, fluxapyroxad, furametpyr, isopyrazam, isotianil, kiralaxyl, mepronil, metalaxyl, metalaxyl-M (mefenoxam), ofurace, oxadixyl, oxylcarboxin, penflufen, penthiopyrad, sedaxane, tecloftalam, thifluzamide, tiadinil, 2-amino-4-methyl-thiazole-5-carboxanilide, N-(4′-trifluoromethylthiobiphenyl-2-yl)-3-difluoromethyl-1-methyl-1H-pyrazole-4-carboxamide and N-(2-(1,3,3-trimethylbutyl)-phenyl)-1,3-dimethyl-5-fluoro-1H-pyrazole-4-carboxamide;
   carboxylic morpholides: dimethomorph, flumorph, pyrimorph;
   benzoic acid amides: flumetover, fluopicolide, fluopyram, zoxamide;
   other carboxamides: carpropamid, dicyclomet, mandiproamid, oxytetracyclin, silthiofarm and N-(6-methoxy-pyridin-3-yl)cyclopropanecarboxylic acid amide;
c) azoles
   triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole;
   imidazoles: cyazofamid, imazalil, pefurazoate, prochloraz, triflumizol;
   benzimidazoles: benomyl, carbendazim, fuberidazole, thiabendazole;
   others: etridiazole, hymexazole and 2-(4-chloro-phenyl)-N-[4-(3,4-dimethoxyphenyl)-isoxazol-5-yl]-2-prop-2-ynyloxy-acetamide;
d) heterocyclic compounds
   pyridines: fluazinam, pyrifenox, 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine;
   pyrimidines: bupirimate, cyprodinil, diflumetorim, fenarimol, ferimzone, mepanipyrim, nitrapyrin, nuarimol, pyrimethanil;
   piperazines: triforine;
   pyrroles: fenpiclonil, fludioxonil;
   morpholines: aldimorph, dodemorph, dodemorph-acetate, fenpropimorph, tridemorph;
   piperidines: fenpropidin;
   dicarboximides: fluoroimid, iprodione, procymidone, vinclozolin;
   non-aromatic 5-membered heterocycles: famoxadone, fenamidone, octhilinone, probenazole, 5-amino-2-isopropyl-3-oxo-4-ortho-tolyl-2,3-dihydro-pyrazole-1-carbothioic acid S-allyl ester;
   others: acibenzolar-5-methyl, ametoctradin, amisulbrom, anilazin, blasticidin-S, captafol, captan, chinomethionat, dazomet, debacarb, diclomezine, difenzoquat, difenzoquat-methylsulfate, fenoxanil, folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1-yl)-6-(2,4,6-trifluorophenyl)-[1,2,4]triazolo-[1,5-a]pyrimidine;
e) carbamates
   thio- and dithiocarbamates: ferbam, mancozeb, maneb, metam, nnethasulphocarb, metiram, propineb, thiram, zineb, ziram;
   carbamates: benthiavalicarb, diethofencarb, iprovalicarb, propamocarb, propamocarb hydrochlorid, valifenalate and N-(1-(1-(4-cyano-phenyl)ethanesulfonyl)-but-2-yl) carbamic acid-(4-fluorophenyl) ester;
f) other active substances
   quanidines: guanidine, dodine, dodine free base, guazatine, guazatine-acetate, iminoctadine, iminoctadine-triacetate, iminoctadine-tris(albesilate);
   antibiotics: kasugamycin, kasugamycin hydrochloride-hydrate, streptomycin, polyoxine, validamycin A;
   nitrophenyl derivates: binapacryl, dinobuton, dinocap, nitrthal-isopropyl, tecnazen,
   organometal compounds: fentin salts, such as fentin-acetate, fentin chloride or fentin hydroxide;
   sulfur-containing heterocyclyl compounds: dithianon, isoprothiolane;
   organophosphorus compounds: edifenphos, fosetyl, fosetyl-aluminum, iprobenfos, phosphorous acid and its salts, pyrazophos, tolclofos-methyl;
   organochlorine compounds: chlorothalonil, dichlofluanid, dichlorophen, flusulfamide, hexachlorobenzene, pencycuron, pentachlorphenole and its salts, phthalide, quintozene, thiophanate-methyl, tolylfluanid, N-(4-chloro-2-nitro-phenyl)-N-ethyl-4-methyl-benzenesulfonamide;
   inorganic active substances: Bordeaux mixture, copper acetate, copper hydroxyide, copper oxychloride, basic copper sulfate, sulfur;
   antifungal biocontrol agents, plant bioactivators: Bacillus pumilius (e.g. isolate NRRL-Nr. B-21661 in RHAPSODY®, SERENADE® MAX and SERENADE® ASO from Fa. AgraQuest Inc., USA);
   others: biphenyl, bronopol, cyflufenamid, cymoxanil, diphenylamin, metrafenone, pyriofenone, mildiomycin, oxin-copper, prohexadione-calcium, spiroxamine, tebufloquin, tolylfluanid, N-(cyclopropylmethoxyimino-(6-difluoro-methoxy-2,3-difluoro-phenyl)-methyl)-2-phenyl acetamide, N′-(4-(4-chloro-3-trifluoromethylphenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)phenyl)-N-ethyl-N-methyl formamidine,
   2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester and N-Methyl-2-{1-[(5-methyl-3-trifluoromethyl-1H-pyrazol-1-yl)-acetyl]-piperidin-4-yl}-N[(1R)-1,2,3,4-tetrahydro-naphthalen-1-yl]-4-thiazolecarboxamide.
g) growth regulators
abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole;
h) herbicides
   acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenylchlor;
   amino acid derivatives: bilanafos, glyphosate, glufosinate, sulfosate;
   aryloxyphenoxypropionates: clodinafop, cyhalofop-butyl, fenoxaprop, fluazifop, haloxyfop, metamifop, propaquizafop, quizalofop, quizalofop-P-tefuryl;
   Bipyridyls: diquat, paraquat;
   (thio)carbamates: asulam, butylate, carbetamide, desmedipham, dimepiperate, eptam (EPTC), esprocarb, molinate, orbencarb, phenmedipham, prosulfocarb, pyributicarb, thiobencarb, triallate;
   cyclohexanediones: butroxydim, clethodim, cycloxydim, profoxydim, sethoxydim, tepraloxydim, tralkoxydim;
   dinitroanilines: benfluralin, ethalfluralin, oryzalin, pendimethalin, prodiamine, trifluralin;
   diphenyl ethers: acifluorfen, aclonifen, bifenox, diclofop, ethoxyfen, fomesafen, lactofen, oxyfluorfen;
   hydroxybenzonitriles: bomoxynil, dichlobenil, ioxynil;
   imidazolinones: imazamethabenz, imazamox, imazapic, imazapyr, imazaquin, imazethapyr;
   phenoxy acetic acids: clomeprop, 2,4-dichlorophenoxyacetic acid (2,4-D), 2,4-DB, dichlorprop, MCPA, MCPA-thioethyl, MCPB, Mecoprop;
   pyrazines: chloridazon, flufenpyr-ethyl, fluthiacet, norflurazon, pyridate;
   pyridines: aminopyralid, clopyralid, diflufenican, dithiopyr, fluridone, fluoroxypyr, picloram, picolinafen, thiazopyr;
   sulfonyl ureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;
   triazines: ametryn, atrazine, cyanazine, dimethametryn, ethiozin, hexazinone, metamitron, metribuzin, prometryn, simazine, terbuthylazine, terbutryn, triaziflam;
   ureas: chlorotoluron, daimuron, diuron, fluometuron, isoproturon, linuron, methabenzthiazuron, tebuthiuron;
   other acetolactate synthase inhibitors: bispyribac-sodium, cloransulam-methyl, diclosulam, florasulam, flucarbazone, flumetsulam, metosulam, ortho-sulfamuron, penoxsulam, propoxycarbazone, pyribambenz-propyl, pyribenzoxim, pyriftalid, pyriminobac-methyl, pyrimisulfan, pyrithiobac, pyroxasulfone, pyroxsulam;
   others: amicarbazone, aminotriazole, anilofos, beflubutamid, benazolin, bencarbazone, benfluresate, benzofenap, bentazone, benzobicyclon, bicyclopyrone, bromacil, bromobutide, butafenacil, butamifos, cafenstrole, carfentrazone, cinidon-ethlyl, chlorthal, cinmethylin, clomazone, cumyluron, cyprosulfamide, dicamba, difenzoquat, diflufenzopyr, Drechsiera monoceras, endothal, ethofumesate, etobenzanid, fenoxasulfone, fentrazamide, flumicloracpentyl, flumioxazin, flupoxam, fluorochloridone, flurtamone, indanofan, isoxaben, isoxaflutole, lenacil, propanil, propyzamide, quinclorac, quinmerac, mesotrione, methyl arsonic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, (3-[2-chloro-4-fluoro-5-(3-methyl-2,6-dioxo-4-trifluoromethyl-3,6-dihydro-2H-pyrimidin-1-yl)-phenoxy]-pyridin-2-yloxy)-acetic acid ethyl ester, 6-amino-5-chloro-2-cyclopropylpyrimidine-4-carboxylic acid methyl ester, 6-chloro-3-(2-cyclopropyl-6-methylphenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)pyridine-2-carboxylic acid methyl ester, and 4-amino-3-chloro-6-(4-chloro-3-dimethylamino-2-fluoro-phenyl)-pyridine-2-carboxylic acid methyl ester.
i) insecticides
   organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
   carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
   pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
   insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
   nicotinic receptor agonists/antagonists compounds: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl-[1,3,5]triazinane;
   GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioic acid amide;
   macrocyclic lactone insecticides: abamectin, emamectin, milbemectin, lepimectin, spinosad, spinetoram;
   mitochondrial electron transport inhibitor (METI) I acaricides: fenazaquin, pyridaben, tebufenpyrad, tolfenpyrad, flufenerim;
   METI II and III compounds: acequinocyl, fluacyprim, hydramethylnon;
   Uncouplers: chlorfenapyr;
   oxidative phosphorylation inhibitors: cyhexatin, diafenthiuron, fenbutatin oxide, propargite;
   moulting disruptor compounds: cryomazine;
   mixed function oxidase inhibitors: piperonyl butoxide;
   sodium channel blockers: indoxacarb, metaflumizone;
   others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluoron, and pyrifluquinazon.

The present invention furthermore relates to agrochemical compositions comprising a mixture of at least one compound I (component 1), at least one component II (component 2) and at least one further active substance useful for plant protection, e.g. selected from the groups a) to i) (component 3), in particular one further fungicide, e.g. one or more fungicide from the groups a) to f), as described above, and if desired one suitable solvent or solid carrier. Those mixtures are of particular interest, since many of them at the same application rate show higher efficiencies against harmful fungi. Furthermore, combating harmful fungi with a mixture of compounds I, components II and at least one fungicide from groups a) to f), as described above, is more efficient than combating those fungi with individual compounds I or individual components II or fungicides from groups A) to F). By applying compounds I and components II together with at least one active substance from groups a) to i) a synergistic effect can be obtained, i.e. more then simple addition of the individual effects is obtained (synergistic mixtures).

According to this invention, applying the compounds I, components II and optionally at least one further active substance different therefrom is to be understood to denote that at least one compound of formula I, the at least one component II and the optional further active substance occur simultaneously at the site of action (i.e. the harmful fungi to be controlled or their habitats such as infected plants, plant propagation materials, particularly seeds, surfaces, materials or the soil as well as plants, plant propagation materials, particularly seeds, soil, surfaces, materials or rooms to be protected from fungal attack) in a fungicidally effective amount. This can be obtained by applying the compounds I, the components II and the optional further active substance simultaneously, either jointly (e.g. as tank-mix) or separately, or in succession, wherein the time interval between the individual applications is selected to ensure that the active substance applied first still occurs at the site of action in a sufficient amount at the time of application of the further active substance(s). The order of application is not essential for working of the present invention.

In the case of successive application, the time interval between the treatments must be such that the desired effect can take place. The time interval may be from a few seconds up to several months, for example up to 6 months. It has to be mentioned that the time interval of more than 10 days and up to several months applies especially to seed treatment where the seeds can be subjected, after having been stored for some months, e.g. for up to 6 months, to a post-treatment. Preferably, the time interval is from a few seconds up to several days, for example up to 6, 8 or 10 days. Preferably, the interval between the treatments is relatively short, i.e. the compounds I and components II and the optional compound(s) Ill are applied within a time interval of from a few seconds up to at most 3 days and in particular up to not more than one day, specifically up to not more than one hour.

In compositions according to the invention comprising at least one compound I (component 1), at least one component II and at least one further active substance (component 3), e.g. one active substance from groups a) to i), the total weight ratio of component 1 and component 2 generally depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:3 to 3:1.

The components can be used individually or already partially or completely mixed with one another to prepare the composition according to the invention. It is also possible for them to be packaged and used further as combination composition such as a kit of parts.

In one embodiment of the invention, the kits may include one or more, including all, components that may be used to prepare a subject agrochemical composition. E. g., kits may include one or more fungicide component(s) and/or an adjuvant component and/or a insecticide component and/or a growth regulator component and/or a herbicide. One or more of the components may already be combined together or preformulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not preformulated. As such, kits may include one or more separate containers such as vials, cans, bottles, pouches, bags or canisters, each container containing a separate component for an agrochemical composition. In both forms, a component of the kit may be applied separately from or together with the further components or as a component of a combination composition according to the invention for preparing the composition according to the invention.

The user applies the composition according to the invention usually from a predosage device, a knapsack sprayer, a spray tank or a spray plane. Here, the agrochemical composition is made up with water and/or buffer to the desired application concentration, it being possible, if appropriate, to add further auxiliaries, and the ready-to-use spray liquor or the agrochemical composition according to the invention is thus obtained. Usually, 50 to 500 liters of the ready-to-use spray liquor are applied per hectare of agricultural useful area, preferably 100 to 400 liters.

According to one embodiment, individual components of the composition according to the invention such as parts of a kit or parts of a binary or ternary mixture may be mixed by the user himself in a spray tank and further auxiliaries may be added, if appropriate (tank mix).

In a further embodiment, either individual components of the composition according to the invention or partially premixed components, e.g. components comprising compounds I, components II and/or active substances from the groups A) to I), may be mixed by the user in a spray tank and further auxiliaries and additives may be added, if appropriate (tank mix).

In a further embodiment, either individual components of the composition according to the invention or partially premixed components, e.g. components comprising compounds I, components II and/or active substances from the groups a) to i), can be applied jointly (e.g. after tankmix) or consecutively.

The invention also relates to the propagation products of plants, and especially the seed comprising, that is, coated with and/or containing, a mixture as defined above or a composition containing the mixture of two or more active ingredients or a mixture of two or more compositions each providing one of the active ingredients. The seed comprises the compositions of the invention in an amount of from 0.01 g to 10 kg per 100 kg of seed.

The compositions of the invention can be used for protecting wooden materials such as trees, board fences, sleepers, etc. and buildings such as houses, outhouses, factories, but also construction materials, furniture, leathers, fibers, vinyl articles, electric wires and cables etc. from fungi.

### BIOLOGICAL EXAMPLES

### Fungicidal Action

The fungicidal effect of the compositions of the invention could be demonstrated by the following tests:

The active compounds, separately or jointly, were prepared as a stock solution comprising 0.25% by weight of active compound in acetone or DMSO. 1% by weight of the emulsifier Uniperol® EL (wetting agent having emulsifying and dispersant action based on ethoxylated alkylphenols) was added to this solution, and the mixture was diluted with water to the desired concentration.

The visually determined percentages of infected leaf areas were converted into efficacies in % of the untreated control:

The efficacy (E) is calculated as follows using Abbot's formula:

E=(1−α/β)·100

α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of mixtures of active compounds were determined using Colby's formula (Colby, S. R. “Calculating synergistic and antagonistic responses of herbicide Combinations”, Weeds, 15, 20-22, 1967) and compared with the observed efficacies.

Colby's formula:

E=x+y−x·y/100
E expected efficacy, expressed in % of the untreated control, when using the mixture of the active compounds A and B at the concentrations a and b
   x efficacy, expressed in % of the untreated control, when using the active compound A at the concentration a
   y efficacy, expressed in % of the untreated control, when using the active compound B at the concentration b

1-15. (canceled)

16. A fungicidal composition, comprising as active components
1) at least one active compound I selected from 3-difluoromethyl-1-methyl-1H-pyrazole-4-carboxylic acid (3′,4′,5′-trifluoro-biphenyl-2-yl)-amide (fluxapyroxade), bixafen, fluopyram, isopyrazam, sedaxane, penflufen and penthiopyrad;
and
2) at least one active component II, selected from the active component groups A) to D):
A) a strobilurin selected from the group consisting of coumethoxystrobin, coumoxystrobin, pyrametostrobin, pyraoxystrobin, N-methoxy-[2-(3,5,6-trichloro-pyridin-2-yloxymethyl)-phenyl]-carbamic acid methyl ester, 2-[2-(5-cyano-2-methyl-phenoxymethyl)-phenyl]-3-methoxy-acrylic acid methyl, ester and 3-methoxy-2-{2-[2-methoxy-5-(methoxyimino-methyl)-phenoxymethyl]-phenyl}-acrylic acid methyl ester;
B) an azole selected from the group consisting of dichlobutrazole, etaconazole and quinconazole;
C) a heterocyclic compound selected from the group consisting of clazafenone (pyriofenone), flutianil, pyrimorph, tebufloquin, and
2-(4-chloro-phenyl)-N-[4-(3,4-dimethoxy-phenyl)-isoxazol-5-yl]-2-prop-2-ynyloxy-acetamide (IIa) 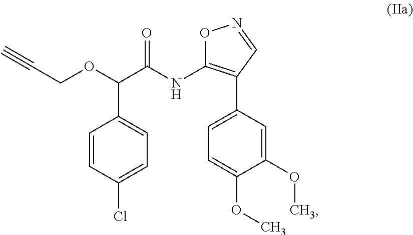 [SMILES: C#CCOC(C(=O)Nc1oncc1-c1ccc(OC)c(OC)c1)c1ccc(Cl)cc1]
2-{1-[2-(5-methyl-3-trifluoromethyl-pyrazol-1-yl)-acetyl]-piperidin-4-yl}-thiazole-4-carboxylic acid methyl-(R)-1,2,3,4-tetrahydro-naphthalen-1-yl-amide (IIb) 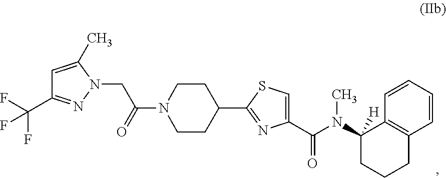 [SMILES: Cc1cc(C(F)(F)F)nn1CC(=O)N1CCC(c2nc(C(=O)N(C)[C@@H]3CCCc4ccccc43)cs2)CC1]
4-cyclopropyl-[1,2,3]thiadiazole-5-carboxylic acid 4-chloro-benzyl ester (IIc) 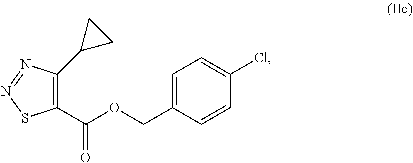 [SMILES: O=C(OCc1ccc(Cl)cc1)c1snnc1C1CC1]
4-cyclopropyl-[1,2,3]thiadiazole-5-carboxylic acid (2,4-dimethoxy-phenyl)-amide (IId) 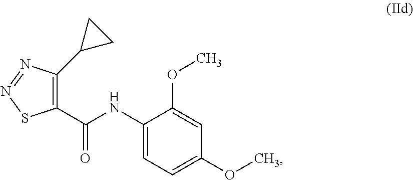 [SMILES: COc1ccc(NC(=O)c2snnc2C2CC2)c(OC)c1]
1-(2,4-dichloro-phenyl)-2-imidazol-1-yl-ethanone O-allyl-oxime (IIe) 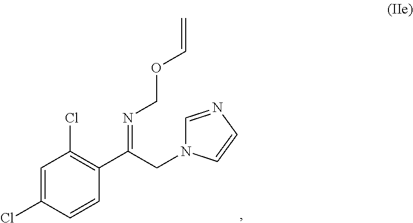 [SMILES: C=COC/N=C(\Cn1ccnc1)c1ccc(Cl)cc1Cl]
5-chloro-1-(4,6-dimethoxy-pyrimidin-2-yl)-2-methyl-1H-benzoimidazole (IIf) 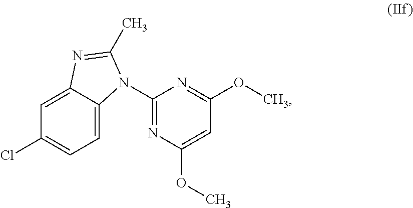 [SMILES: COc1cc(OC)nc(-n2c(C)nc3cc(Cl)ccc32)n1]
and 3-(2,3-dimethyl-5-p-tolyl-isoxazolidin-3-yl)-pyridine (IIg) 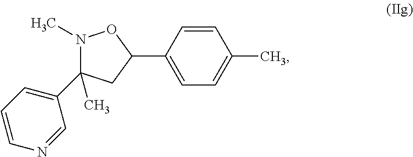 [SMILES: Cc1ccc(C2CC(C)(c3cccnc3)N(C)O2)cc1]
D) a biological selected from the group consisting of
cocamidopropyl-betaine,
Ulocladium oudemansii,
chitosan,
Trichoderma atroviride,
Ampelomyces quisqualis,
Aspergillus flavus,
Aureobasidium pullulans,
Bacillus subtilis,
Candida oleophila,
Candida saitoana,
Clonostachys rosea f. catenulate,
Coniothyrium minitans,
Cryphonectria parasitica,
Cryptococcus albidus,
Fusarium oxysporum,
Metschnikowia fructicola,
Microdochium dimerum,
Phlebiopsis gigantea,
Pseudozyma flocculosa,
Pythium oligandrum,
Reynoutria sachlinensis,
Talaromyces flavus,
Trichoderma asperellum,
Trichoderma atroviride,
Trichoderma harzianum,
a mixture of Trichoderma harzianum and Trichoderma viride,
a mixture of Trichoderma polysporum and Trichoderma harzianum,
Trichoderma stromaticum,
Trichoderma virens,
Trichoderma viride, and
Trichoderma viride strain TV1,
in a synergistically effective amount.

17. The composition as claimed in claim 16, where active compound I is selected from the group consisting of 3-difluoromethyl-1-methyl-1H-pyrazole-4-carboxylic acid (3′,4′,5′-trifluoro-biphenyl-2-yl)-amide (fluxapyroxade), bixafen, fluopyram, isopyrazam and penthiopyrad.

18. The composition as claimed in claim 17, where active compound I is selected from the group consisting of 3-difluoromethyl-1-methyl-1H-pyrazole-4-carboxylic acid (3′,4′,5′-trifluoro-biphenyl-2-yl)-amide (fluxapyroxade), bixafen and isopyrazam.

19. The composition as claimed in claim 16, where active component II is selected from the group consisting of clazafenone, flutianil, pyrimorph, tebufloquin, the compound of formula IIa, the compound of formula IIb, the compound of formula IIf, chitosan, Trichoderma atroviride and Ulocladium oudemansii.

20. The composition as claimed in claim 19, where active component II is selected from the group consisting of clazafenone, flutianil, pyrimorph, the compound of formula IIa, the compound of formula IIb, chitosan, Trichoderma atroviride and Ulocladium oudemansii.

21. The composition as claimed in claim 16, comprising the at least one active compound I and the at least one active component II in a total weight ratio of from 100:1 to 1:100.

22. The composition as claimed in claim 16, additionally comprising a further active substance III selected from fungicides different from compounds I and components II, herbicides, insecticides and growth regulators.

23. The composition as claimed in claim 16, additionally comprising a solvent or solid carrier.

24. A method for controlling phytopathogenic fungi, comprising treating the fungi, their habitat or the plant propagation material, the soil, the plants or the materials to be protected against fungal attack with an effective amount of at least one active compound I in combination with an effective amount of the composition as defined in claim 16.

25. The method as claimed in claim 24, wherein the at least one active compound I and the at least one active component II are applied simultaneously, that is jointly or separately, or in succession.

26. The method as claimed in claim 24, where active compound I is selected from the group consisting of 3-difluoromethyl-1-methyl-1H-pyrazole-4-carboxylic acid (3′,4′,5′-trifluoro-biphenyl-2-yl)-amide (fluxapyroxade), bixafen, fluopyram, isopyrazam and penthiopyrad.

27. The method as claimed in claim 26, where active compound I is selected from the group consisting of 3-difluoromethyl-1-methyl-1H-pyrazole-4-carboxylic acid (3′,4′,5′-trifluoro-biphenyl-2-yl)-amide (fluxapyroxade), bixafen and isopyrazam.

28. The method as claimed in claim 24, where active component II is selected from the group consisting of clazafenone, flutianil, pyrimorph, tebufloquin, the compound of formula IIa, the compound of formula IIb, the compound of formula IIf, chitosan, Trichoderma atroviride and Ulocladium oudemansii.

29. The method as claimed in claim 28, where active component II is selected from the group consisting of clazafenone, flutianil, pyrimorph, the compound of formula IIa, the compound of formula IIb, chitosan, Trichoderma atroviride and Ulocladium oudemansii.

30. The method as claimed in claim 24, comprising the at least one active compound I and the at least one active component II in a total weight ratio of from 100:1 to 1:100.

31. The method as claimed in claim 24, additionally comprising a further active substance III selected from fungicides different from compounds I and components II, herbicides, insecticides and growth regulators.

32. A method for protection of plant propagation material from phytopathogenic fungi comprising contacting the plant propagation material with an effective amount of at least one active compound I in combination with an effective amount of the composition as defined in claim 16.

33. The method as claimed in claim 32, wherein the at least one active compound I and the at least one active component II are applied simultaneously, that is jointly or separately, or in succession.

34. A method for protecting plants after germination from the attack of foliar phytopathogenic fungi, which comprises treating the plant propagation material from which the plants are to grow with an effective amount of at least one active compound I in combination with an effective amount of the composition as defined in claim 16.

35. The method as claimed in claim 34, wherein the at least one active compound I and the at least one active component II are applied simultaneously, that is jointly or separately, or in succession.

36. Plant propagation material comprising the composition as defined in claim 16 in an amount of from 0.01 g to 10 kg per 100 kg of plant propagation material.
